(19) United States
(12) Patent Application Publication
(10) Pub. No.: US 2004/0054678 A1
(43) Pub. Date: Mar. 18, 2004

(54) Distribution device, terminal device, and program and method for use therein

(76) Inventors: Ryuichi Okamoto, Moriguchi (JP); Masayuki Kozuka, Arcadia, CA (US); Masataka Minami, Burbank, CA (US); Mitsuhiro Inoue, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/433,909

(22) PCT Filed: Dec. 6, 2001
(86) PCT No.: PCT/US01/46284

(30) Foreign Application Priority Data
Dec. 8, 2000 (US) 09/731,831
Jan. 11, 2001 (US) 09/757,577
Jan. 11, 2001 (US) 09/757,578

(51) Int. Cl. G06F 17/00

(52) U.S. Cl. 707/100

(57) ABSTRACT

A distribution device (1) stores a group of two or more digital contents and right management information (UR.Us) indicating a user's right range for the group in an interrelated manner. The distribution device transmits a digital content in the group to the NetDRM terminal device (2) together with an LT as requested by the user. Here, the distribution device updates the right management information to reduce the right range. When an updated LT is returned from the user, the distribution device increases the reduced right range based on a partial right range indicated by the updated LT. The distribution device again transmits art that indicates a partial right range of the increased right range and a different digital content in the group to the NetDRM terminal device (2) as requested by the user.

### TECHNICAL FIELD

The present invention relates to a distribution device, a terminal device, and a program and a method for use in these devices. In particular, the present invention relates to improvements for enabling users to suitably use contents while realizing copyright protection by imposing limitations on content usage.

### BACKGROUND ART

In recent years, the industrial community is keeping a close eye on developments of content distribution services provided via distribution devices. In the field of content distribution service where competition between a number of entrants is expected to be intensified further, the key to success isgraspingtrendsincustomers' demands and providing such content distribution services that satisfy these demands. The recent trend in customer's demands can be considered as follows. Most users want to view or listen to a wide variety of contents in a time when things in fashion change rapidly. After viewing or listening to various contents once or twice, such users tend to cease viewing or listening to those they do not like and continue viewing or listening to those they really like many times. These users seem to be particular about what they like.

However, conventional distribution devices are designed to sell out contents by distributing them via a network. Such distribution neither satisfies the above described user demand for viewing or listening to a wide variety of contents, nor considers the fact that the number of times each content is viewed or listened to is different. Additionally, such conventional distribution devices that are designed to sell out contents have established the price structure in which the uniform price is set for all contents regardless of their viewing or listening frequency. Users who want to view or listen to various contents may be discontent with this system that requires them to pay for the contents viewed or listened to only a few times as much as for the contents viewed or listened to many times. As described above, the content distribution services provided via the conventional distribution devices hardly satisfy the user demand for viewing or listening to a wide variety of contents.

### DISCLOSURE OF THE INVENTION

The object of the present invention, accordingly, is to provide a distribution device that can increase customer satisfaction for those users who want to view or list n to a wide variety of contents.

The above object can be achieved by a distribution device, including: a storage unit storing license information; a transmission unit operable to read a part of the license information, transmit the read part together with a digital content to a user, and update the license information so as to be a remaining part, the remaining part being the license information excluding the read part; and an increase unit operable to (a) receive a decreased part that is the transmitted part decreased according to usage of the digital content, when the decreased part is returned from the user, and (b) increase the remaining part based on the received decreased part by updating the license information.

According to the present invention, license information that is right relating to a usage of a content is managed by the distribution device even after the content has been distributed. Also, when the decreased part of the license information that has been decreased according to a usage of the content is returned from the user, the increase unit increases the license information based on the returned decreased part. Here, the license information is increased more, in relation to less usage of the transmitted content, such that the user stops to view the content after viewing it once or twice.

Because the degree of increase of the license information is changed according to the usage of the content, unfairness between a frequently used content and a less frequently used content can be removed, thereby increasing customer satisfaction.

Here, when the user requests another digital content, the transmission unit may read another part of the license information updated by the increase unit and transmit the read other part together with the other digital content, to the user.

With this construction, the license information increased based on the returned part can be re-allocated to a different digital content. This allows a new price structure to be established, in which a part of the license information can be freely allocated to contents that belong to a group after a fixed price for the license information allocated to the group is paid. This new price structure can satisfy the user demand for viewing or listening to a variety of contents.

Here, the license information stored by the storage unit may be a total usage count “s”, “s” being an integer that satisfies “s≧2”, the read part may be a usage count “t” for the digital content, “t” being an integer that satisfies “t≦s”, and the license information stored by the storage unit may be updated to be a remaining usage count “s−t” after the digital content and the read part have been transmitted.

Also, the decreased part may be a usage count “u”, “u” being an integer that satisfies “u<t”, and the increase unit may increase the remaining usage count “s−t” to a remaining usage count “s−t+u”.

Also, the transmission unit may read a usage count. “v” that is the other part of the updated license information from the remaining usage count “s−t+u”, and transmit the read usage count “v” together with the other digital content, “v” being an integer that satisfies “v≦s−t+u”.

With this construction, a remaining usage count “U” of a usage count allocated to a content can be added to a usage count “s−t” in the distribution server, and a usage count “v” to be allocated to a different content can be determined from the added usage count “s−t+u”. Due to this, when the user who wishes to view or listen to a variety of contents no longer wants to view or listen to a content after viewing or listening to it once or twice, he or she can re-allocate the remaining usage count to a different content. As a result, the allocable usage count to a different content increases further.

Here, the distribution device may further includes: a first reception unit operable to receive, from the user, media unique information that is unique to a recording medium to which the digital content is to be written; a second reception unit operable to receive, from the user, media unique information that is unique to a recording medium to which the decreased part has been recorded; and a judgment unit operable to judge whether the media unique information received by the first reception unit and the media unique information received by the second reception unit match or not, wherein the increase unit increases the remaining part to update the license information only when a judgment result by the judgment unit is affirmative.

With this construction, the increase unit increases the license information only when the authenticity of the media unique information is verified. Therefore, a malicious user who sends an unauthorized part of the license information to the distribution device, if any, fails to update the license information and to make unfair profits. Also, because not being required to input information such as a password for verifying the authenticity, the user can readily increase the license information.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 shows the structure of a system relating to a first embodiment of the present invention;

FIG. 2 shows the internal structure of a digital work distributed in the system relating to embodiments of the present invention;

FIG. 3 shows the structure of a content distribution system;

FIG. 4 shows the data format of an LT in the first embodiment of the present invention;

FIG. 5 shows the internal structure of a portable medium 3;

FIG. 6 shows the internal structure of a NetDRM terminal device 2:

FIG. 7 shows the detailed structures of a NetDRM client 8 and a secure I/O plug-in 10;

FIG. 8 shows the internal structure of a distribution device 1;

FIG. 9 shows the storage content of a right management information database 19 before a user signs up the service;

FIG. 10A shows an example of “NDRM_CONTENT”;

FIG. 10B shows an example of “NDRM_CONTENTS_FOR_URC”;

FIG. 11 shows the storage content of the right management information database 19 to which “NDRM_USER” and “NDRM_CLIENT” have been added;

FIG. 12A shows ID information for users “David Moor”, “Alice Liddell”, and “John Brown” to be generated when they sign up the service;

FIG. 12B shows “NDRM_CLIENT” set for three users who respectively have user_ids “AA00001” to “AA00003”;

FIG. 13 shows the storage content of the right management information database 19 after digital works have been purchased;

FIG. 14 shows “NDRM_URUS” set for a plurality of users who respectively have user_ids “AA00001” to “AA00004”;

FIG. 15 shows the storage content of the right management information database 19 after Move-Out has been performed;

FIG. 16 shows “NDRM_MOVEOUT_BACKUP_LT” set for a plurality of users who respectively have user_ids “AA00001” to “AA00003”;

FIG. 17 shows a processing sequence of the system when Move-Out of content A is performed;

FIGS. 18A and 18B show how the portable medium 3 to which content A has been written is used;

FIG. 19 shows a processing sequence of the system when Move-In of content A is performed;

FIG. 20 shows a processing sequence of the system when Move-Out of content B is performed;

FIG. 21 shows the operation for cutting and downloading a usage time period of 50 minutes from an available usage time period of 60 minutes (state sj1) in UR-Us, and writing the usage time period of 50 minutes tog ther with content A to the portable medium 3;

FIGS. 22A and 22B show how the usage time period written in the portable medium 3 is reduced to 40 minutes after content A was reproduced for 10 minutes;

FIG. 23 shows how the reduced usage time period of 40 minutes is uploaded to the distribution device 1 and is added to the UR-Us in the distribution device 1;

FIG. 24 shows an example of right management information (UR-Us) including usage conditions for a plurality of usage actions such as viewing and printing;

FIG. 25 shows the data format of an LT including a plurality of LT tag blocks;

FIG. 26A shows the UR-Us before the usage condition is cut out;

FIG. 26B shows the UR-Us and the LT after the usage condition has been cut out;

FIG. 27 shows an example of P-condition set for a digital work that includes audio;

FIG. 28 shows an example case where a plurality of usage actions such as viewing and printing are available;

FIG. 29 shows the data format of an LT for transmitting P-condition for each usage action;

FIG. 30A shows the UR-Us before the usage condition is cut out;

FIG. 30B shows the UR-Us and the LT after the usage condition has been cut out;

FIG. 31 shows an example of the UR-Us in which S-condition is set;

FIG. 32 shows how a concurrent usage count is updated when download or Move-Out of content is performed, described in the same manner as in FIG. 17;

FIG. 33 shows how the concurrent usage count is updated when Move-In of content is performed, described in the same manner as in FIG. 19;

FIG. 34A shows the UR-Us before the usage condition is cut out;

FIG. 34B shows the UR-Us and the LT after the usage condition has been cut out;

FIG. 35 is a flowchart showing the operation procedure of an LT transmission unit 24 relating to a fifth embodiment of the present invention;

FIG. 36 is a flowchart showing the operation procedure of a Move-Out control unit 14;

FIG. 37 is a flowchart showing the operation procedure of a media write unit 15 in a secure I/O plug-in 10;

FIG. 38 is a flowchart showing the operation procedure of a media read unit 17 in the secure I/O plug-in 10;

FIG. 39 is a flowchart showing the operation procedure of a Move-In control unit 16 in the NetDRM client 8 when Move-In is performed;

FIG. 40 is a flowchart showing the operation procedure of a Move-In update unit 26 and a verification unit 27 when Move-In is performed;

FIG. 41 is a flowchart showing a combining process executed in step S65;

FIG. 42 is a flowchart showing a UR-Us reflection process executed in step S66;

FIG. 43 shows the data format of an LT in a sixth embodiment of the present invention;

FIG. 44 shows a plurality of NetDRM terminal devices owned by a user in a seventh embodiment of the present invention;

FIG. 45 is a flowchart showing the operation procedure of a Move-In control unit 16 relating to the seventh embodiment of the present invention;

FIG. 46 shows a plurality of NetDRM terminal devices connected to one another via a home network relating to an eighth embodiment of the present invention;

FIG. 47 shows the data format of an LT defined to enable move-acceptability to be set in various levels;

FIG. 48 is a flowchart showing the operation procedure of a Move-In control unit 16 in a ninth embodiment of the present invention;

FIG. 49 shows encrypted content and an LT each being supplied on a different route;

FIG. 50 shows how a NetDRM terminal device 2 r lating to an eleventh embodiment of the present invention performs Move-Out; and

FIG. 51 shows the structure of the physical layer of an SD memory card 100.

### BEST MODE FOR CARRYING OUT THE INVENTION

(First Embodiment)

As a first embodiment of a distribution device 1 and a terminal device 2 relating to the present invention, the following describes a system including the distribution device 1 and the terminal device 2, with reference to the drawings.

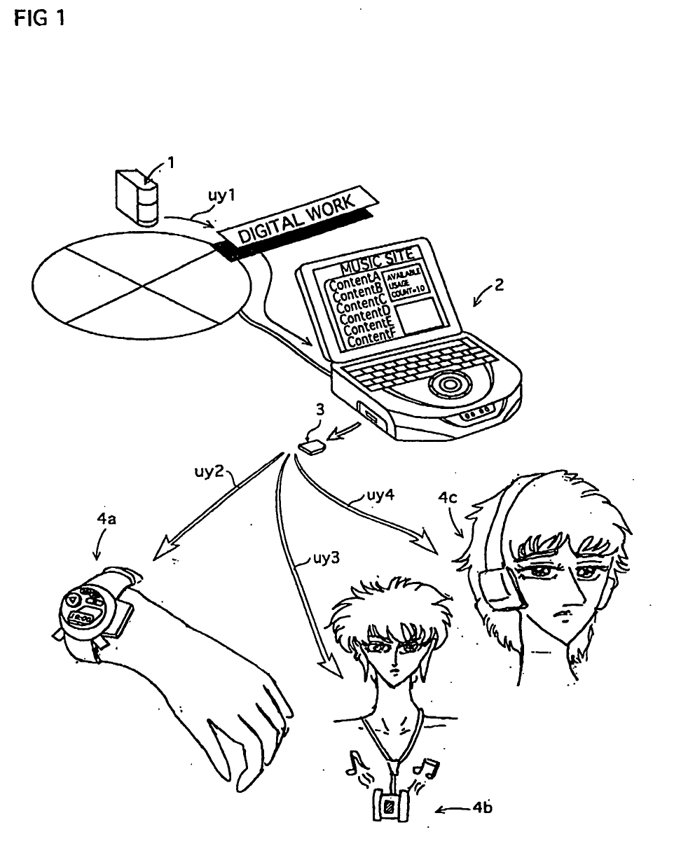

FIG. 1 shows the structure of the system to which the first embodiment of the present invention relates. The system is roughly composed of the distribution device 1, the NetDRM (Network Digital Rights Management) terminal device 2, a portable medium 3, and PDs (Portable Devices) 4a, 4b, and 4c. The distribution device 1 stores digital works and distributes a digital work as requested by a user. The NetDRM terminal device 2 is a notebook-sized personal computer that receives the distributed digital work via the broadband Internet or a mobile phone network. The NetDRM terminal device 2 writes the received digital work to the portable medium 3. The PDs 4a, 4b, and 4c respectively are wearable devices of wristband type, strap type, and headphone type, and can reproduce the digital work written to the portable medium 3. This system allows a digital work not only to be obtained as indicated by arrow uy1 but also to be recorded onto the portable medium 3 and reproduced by these wearable PDs 4a, 4b, and 4c taken with the user as indicated by arrows uy2, uy3, and uy4. This enables the user to enjoy reproducing encrypted content without constraints of the time and place.

The system shown in FIG. 1 has the following three characteristics in terms of right management. The first characteristic is that right management information (equivalent to “license information” in the disclosure of the invention) is set not for each content but for a group of a plurality of contents. The second characteristic is that a part of the right range indicated by the right management information can be allocated to each content in the group. The third characteristic is that a number of opportunities are available for this right range allocation. Specifically, the allocation is possible not only before but also after digital works are downloaded.

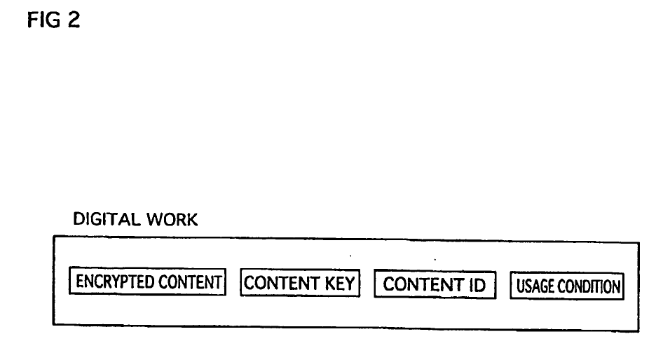

To realize these three characteristics, a digital work is constructed as shown in FIG. 2. A digital work distributed in the present embodiment is imposed upon limitations to its usage, according to the service to which the user has signed up. FIG. 2 shows the internal structure of the digital work distributed in the system of the present embodiment. As FIG. 2 shows, the digital work is made up of encrypted content that is encrypted digital data, a content key used for decrypting the encrypted content, a content ID that uniquely identifies the digital work, and a usage condition that is an allocated part of the right range of the right management information. The present embodiment assumes that the digital work is music and its usage action is reproduction (“play”). As the encrypted content is music, each device shown in FIG. 1 has the copyright protection function that conforms to the SDMI (Secure Digital Music Initiative).

In the first embodiment, the right range of the right management information is expressed by the total number of times contents in the group can be used (hereafter referred to as the “available usage count”). Accordingly, the allocation of the right range in the first embodiment means free allocation of the available usage count indicated by the right management information. As one example, when the available usage count is 10, a usage count of 1 to 10 can be freely allocated to each content in the group.

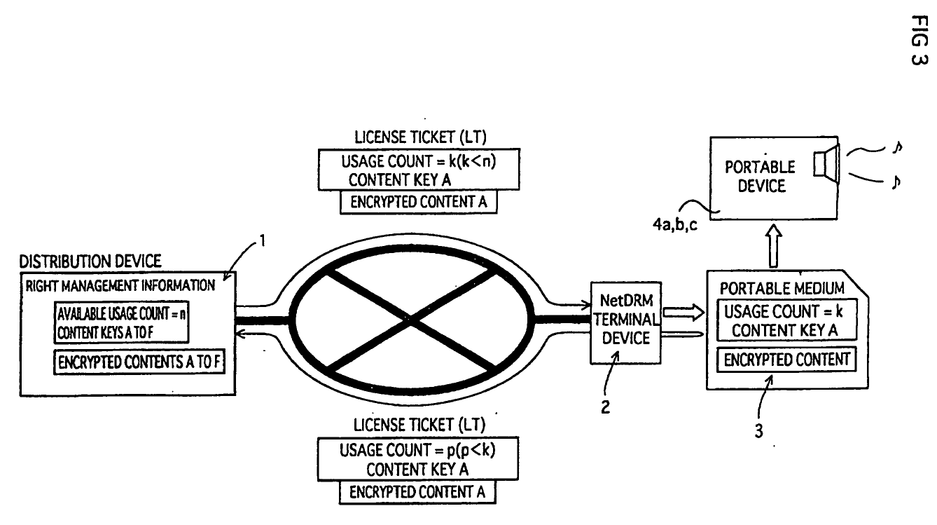

Each device that constitutes the system in FIG. 1 is constructed as shown in FIG. 3. FIG. 3 shows the structure of the content distribution system.

The distribution device 1 includes encrypted contents (contents A to F in the figure) corresponding to a plurality of digital works that can be received by the user who has signed up the service, and right management information for the user. The distribution device 1 executes (i) processing for transmitting a license ticket (hereafter simply, an “LT”) to the NetDRM terminal device 2 owned by the user and (ii) processing for receiving the LT uploaded by the user. Here, the right management information includes the available usage count (n in the figure) for a plurality of digital works, and content keys A to F used for decrypting these encrypted contents. The LT to be transmitted by the distribution device 1 includes a part (k in the figure) of the available usage count, and a content key (content key A). As the above third characteristic shows, the user can freely select a digital work to be downloaded from the group and freely allocate a usage count out of the available usage count, to the selected digital work.

The NetDRM terminal device 2 executes (i) processing for writing the encrypted content downloaded, from the distribution device 1 to the portable medium 3, together with the LT including the content key and the allocated usage count. The NetDRM terminal device 2 also executes (ii) processing for uploading the LT including the content key and the usage count to the distribution device 1.

The portable medium 3 is a recording medium such as a semiconductor memory to which the content key, the allocated usage count, and the encrypted content are written.

The PDs 4a, 4b, and 4c are compact portable devices for reproducing the digital work written to the portable medium 3. Every time when reproducing the digital work once, the PDs 4a, 4b, or 4c decrements the allocated usage count recorded on the portable medium 3 by one.

The importance in this system lies in the presence of a transmission path for uploading the LT from the NetDRM terminal device 2 to the distribution device 1. The LT uploaded from the NetDRM terminal device 2 to the distribution device 1 indicates the remaining usage count. Therefore, the distribution device 1 can re-allocate the remaining usage count that had once been allocated to the digital work, to a different digital work. To be specific, this system not only allows free allocation of the available usage count to a digital work when downloading the digital work, but also allows re-allocation of the remaining usage count to a different digital work by uploading the remaining usage count to the distribution device 1. This enables the available usage count to be allocated freely to each digital work both before and after the digital work is downloaded.

<LT Structure>

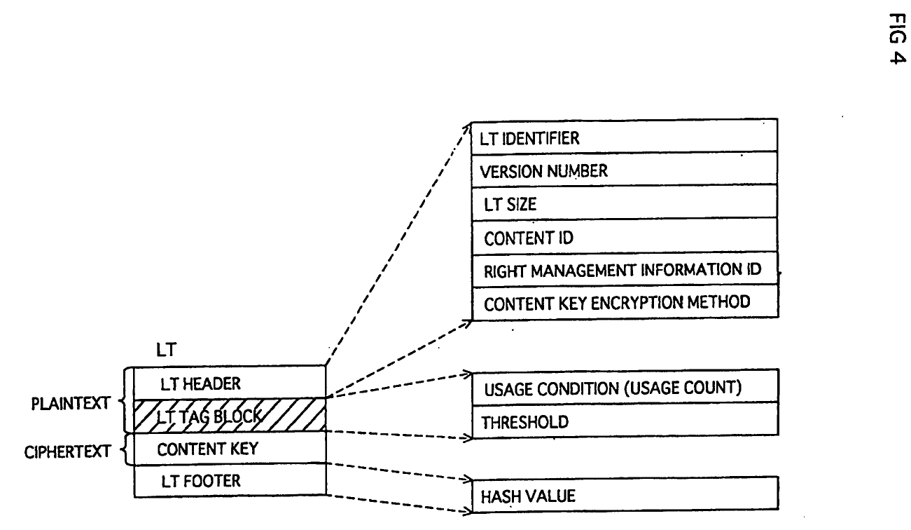

The following describes the data format of an LT. To be specific, the following describes an LT that serves as transmission configuration of a usage condition, a content ID, and a content key. FIG. 4 shows the data format of an LT in the first mbodiment of the present inv ntion.

As shown in the figure, the LT is made up of an LT header, an LT tag block, a content key, and an LT footer. The LT header includes an identifier for the LT (LT identifier), a version number of a system that accepts the LT, a size of the LT (LT size), a content ID, right management information ID that uniquely identifies right management information managed by the distribution device 1, and a content key encryption method that is an encryption method using the content key. The LT tag block includes a usage condition that is a usage count, and a usage threshold. The usage count included in the LT tag block is a part of the available usage count managed by the distribution device 1, and the usage threshold indicates a minimum usage time period to be regarded as one count.

The LT footer includes a hash value that is a part of an operation result obtained by concatenating the LT header, the LT tag block, and the content key, and inputting the concatenated data into a hash function. The hash function is a unidirectional function and is characterized in that only a partial change in an input value creates a greater difference in its resulting value. The hash function is further characterized in that the hash value is extremely difficult to predict using the input value. The hash value written in the LT footer is used for detecting an unauthorized alteration, if any, in the usage count included in the LT tag block when the NetDRM terminal device 2 (or the distribution device 1) receives the LT.

This detection of the unauthorized alteration in the usage count is performed as follows. When receiving the LT, the NetDRM terminal device 2 or the distribution device 1 concatenates the LT header, the LT tag block, and the content key in the received LT, and inputs the concatenated data into a hash function, so as to obtain a hash reference value (C_HASH-Ref value). The NetDRM terminal device 2 or the distribution device 1 then compares (a) the C_HASH-Ref value obtained in this way with (b) the hash value included in the LT footer. The LT header, the LT tag block, and the content key being the same as those at the time of transmission by the distribution device 1 means the C_HASH-Ref value being the same as the hash value included in the LT footer. When there is an unauthorized alteration in the usage count, the calculated C_HASH-Ref value greatly differs from the hash value included in the LT footer. The purpose of the hash value being stored in the LT footer is to enable the device receiving the LT to detect such an unauthorized alteration.

<Portable Medium 3>

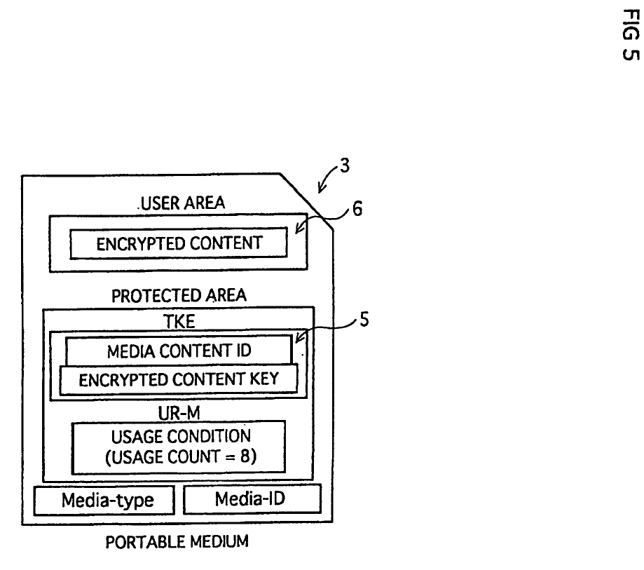

The following describes the internal structure of the portable medium 3. FIG. 5 shows the internal structure of the portable medium 3. As the figure shows, the portable medium 3 includes a protected area 5 that can be accessed only by authorized devices, and a user area 6 that can be accessed by any devices including unauthorized ones. The portable medium 3 stores a media ID that is an identifier unique to the portable medium 3 and a media type that indicates a type (for example, an SD memory card, a memory stick, or the like) of the portable medium 3. Encrypted content is written in the user area 6, whereas a media content ID, an encrypted content key, and UR-M are written in the protected area 5. The encrypted content key is a content key that has been encrypted using the media ID, and is processed in a pair with the media content ID (the pair of the encrypted content key and media content ID is shown as TKE (Title Key Entry) in the figure)). The UR-M (Usage Rule on Media) indicates the usage condition.

<NetDRM terminal device 2>

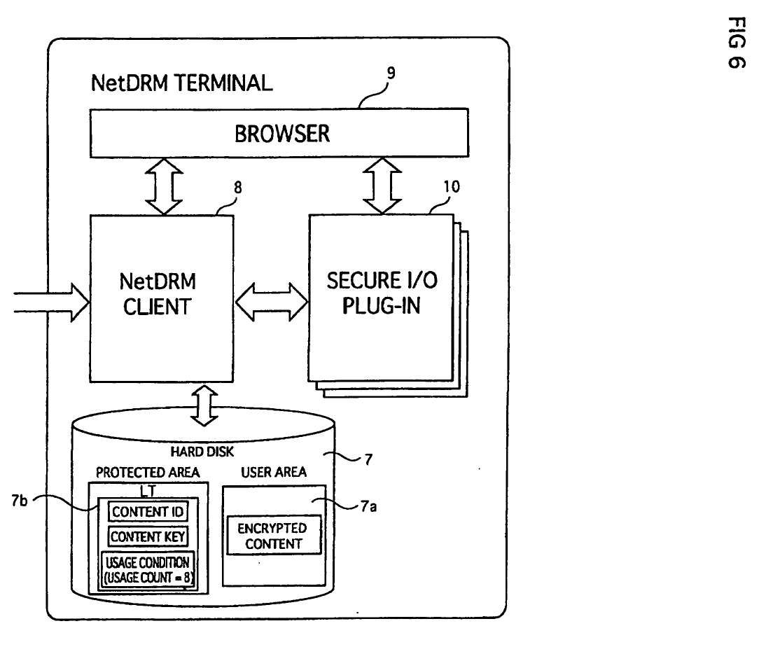

FIG. 6 shows the internal structure of the NetDRM terminal device 2. As the figure shows, the NetDRM terminal device 2 includes a HD 7, a NetDRM client 8, a browser 9, and a secure I/O plug-in 10.

The HD (Hard Disk) 7 includes a user area 7a that can be accessed by general users, and a protected area 7b that can be accessed only by the NetDRM client 8 and the secure I/O plug-in 10.

The NetDRM client 8 is a program for managing, in cooperation with the distribution device 1, a digital work via a network (NetDRM). The NetDRM client 8 controls download of a digital work from the distribution d vice 1 to the NetDRM terminal device 2 and upload of a digital work from the NetDRM terminal device 2 to the distribution device 1. The NetDRM client 8 writes the downloaded LT into the protected area 7b and encrypted content in the downloaded digital work into the user area 7a. The NetDRM client 8 is uniquely identified by an identifier called a client ID.

The browser 9 is an application program that enables the user to view distribution sites operated by the distribution device 1. Via this browser 9, the user can register his or her ID information into the distribution device 1 when signing up the distribution service, so that the user is subsequently allowed to select a digital work to be downloaded or uploaded. When a digital work to be downloaded is selected, a URL of a site from which the selected digital work is to be downloaded, an identifier of the selected digital work, and other information are delivered to the NetDRM client 8, so that downloading of the digital work is proceeded.

The secure I/O plug-in 10 is a program that is plugged in a computer for enabling an access to the portable medium 3. The secure I/O plug-in 10 realizes reproduction of a digital work stored in the HD 7, and also realizes “move” of the digital work between the NetDRM terminal device 2 and the portable medium 3. “Move” referred to herein intends to mean the processing of writing data that has been written in a source recording medium to a target recording medium, and deleting the data originally present in the source recording medium. “Move” differs from “copy” in that the originally present data is deleted. Here, writing a digital work to the portable medium 3 is realized by “move” in the present embodiment for the purpose of preventing unnecessary duplication of the digital work. “Move” performed by the secure I/O plug-in 10 can be divided into two types. One type is writing the digital work stored in the HD 7 to the portable m dium 3 and deleting the digital work from the HD 7 (this processing is hereafter referred to as “Move-Out”). The other type is uploading the UR-M recorded in the portable medium 3 to the distribution device 1 after converting it into an LT, and making the digital work in the portable medium 3 irreproducible (this processing is hereafter referred to as “Move-In”).

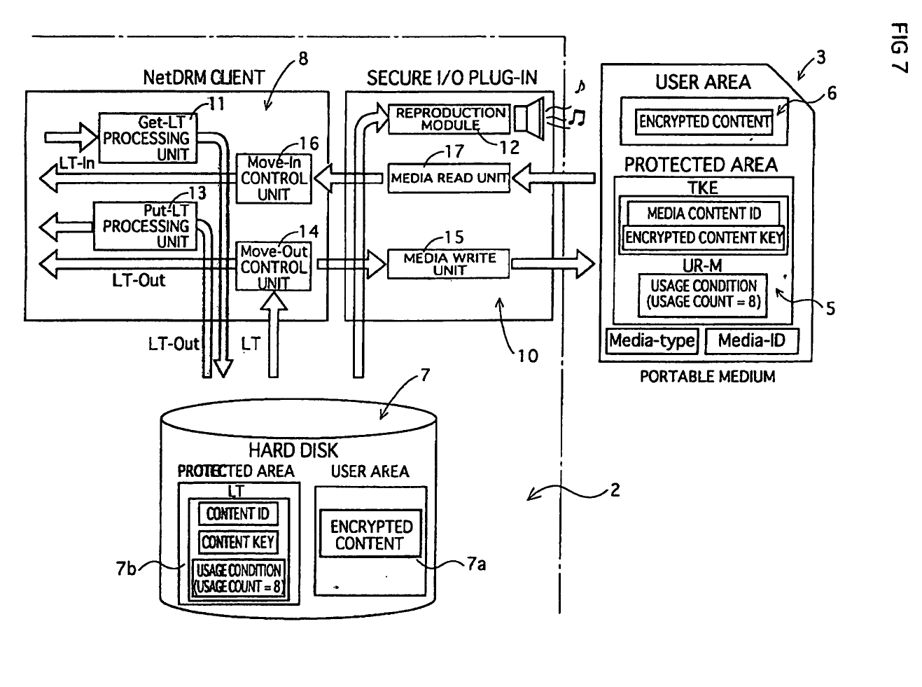

Among the above described components, the following describes the internal structures of the NetDRM client 8 and the secure I/O plug-in 10 in more detail. FIG. 7 shows the detailed structures of the NetDRM client 8 and the secure I/O plug-in 10. As the figure shows, the NetDRM client 8 and the secure I/O plug-in 10 include a Get-LT processing unit 11, a reproduction module 12, a Put-LT processing unit 13, a Move-Out control unit 14, a media write unit 15, a Move-In control unit 16, and a media read unit 17.

The Get-LT processing unit 11 performs “Get-LT” as requested by the user. “Get-LT” is the processing for obtaining a digital work and an LT from the distribution device 1. When Get-LT is requested, the Get-LT processing unit 11 receives a digital work and an LT sent from the distribution device 1 via a network, and verifies the authenticity of the LT using a hash value stored in the LT footer of the received LT. When the authenticity of the LT is verified, the Get-LT processing unit 11 writes encrypted content into the user area 7a and the LT into the protected area 7b.

The reproduction module 12 decrypts the encrypted content stored in the user area 7a using a content key included in the LT stored in the protected area 7b in the HD 7, to reproduce the digital work. Here, the reproduction module 12 also keeps a time period during which the digital work is being reproduced, and decrements the usage count by one when the time period exceeds the usage threshold.

The Put-LT processing unit 13 performs “Put-LT” when the user no longer wants to use the digital work on the NetDRM terminal device 2. “Put-LT” is the processing for uploading the LT included in the protected area 7b to the distribution device 1, and then deleting the LT stored in the protected area 7b. The completion of Put-LT results in the digital work being made unavailable to the user. After that, the Put-LT processing unit 13 uploads the LT to the distribution device 1, and waits for the remaining usage count indicated by this LT to be reflected in the right management information database 19. Receiving notification of normal processing end from the distribution device 1, the Put-LT processing unit 13 ends Put-LT.

The components described so far relate to usage of a digital work within the NetDRM terminal device 2. Now, the following describes components relating to move of a digital work.

The Move-Out control unit 14 performs Move-Out when the portable medium 3 is connected to the NetDRM terminal device 2 and the user instructs to record a digital work onto the portable medium 3 for using the digital work. Here, the Move-Out control unit 14 creates a backup copy of an LT stored in the device, and then delivers the LT and the digital work to the secure I/O plug-in 10. The Move-Out control unit 14 waits for the delivered LT and the digital work to be written to the portable medium 3. When this writing is complete, the Move-Out control unit 14 requests delivery of media unique information (a media ID, a media content ID, and a media type) of this portable medium 3 to which the LT and the digital work have been written. Upon receipt of the media unique information, the Move-Out control unit 14 transmits the LT (LT-Out) and the media unique information, together with its client ID, to the distribution device 1. The Move-Out control unit 14 then deletes the LT from the protected area 7b and makes the encrypted content in the user area 7 an irreproducible.

The media write unit 15 receives the LT from the NetDRM client 8 and extracts a content key and a content ID from the received LT. When Move-Out is performed, the media write unit 15 then converts a usage condition included in the LT into UR-M. After this conversion, the media write unit 15 encrypts the content key using the media ID, allocates an identifier (media content ID) in a format unique to the portable medium 3, and writes the UR-M, the encrypted content key, and the media content ID, into the protected area 5 of the portable medium 3. The media write unit 15 also converts the encrypted content into a format unique to the portable medium 3, and writes it into the user area 6 of the portable medium 3. To be more specific, when areas in the portable medium 3 are managed by a file system as one example, the media write unit 15 converts the encrypted content into a file and writes the file to the portable medium 3. As written in the protected area 51 the usage condition is not exposed to an unauthorized access, such as tampering, and therefore, the digital work can be used in a secure manner. By Move-Out, a digital work downloaded into the NetDRM terminal device 2 can be used not only on the NetDRM terminal device 2 but also on other devices such as the PDs 4a, 4b, and 4c.

The Move-In control unit 16 makes the secure I/O plug-in 10 execute (a) processing for converting the UR-M into an LT at Move-In and (b) processing for making the digital work irreproducible. The Move-In control unit 16 then waits for the LT to be delivered from the secure I/O plug-in 10. Upon receipt of the LT, the Move-In control unit 16 uploads the LT to the distribution device 1 as in the case of Put-LT, and waits for the remaining usage count indicated by this LT to be reflected by the distribution device 1. Upon receipt of notification of normal processing end from the distribution device 1, the Move-In control unit 16 ends Move-In.

The media read unit 17 reads the UR-M, the encrypted content key, and the media content ID from the protected area 5 when Move-In is performed, converts the UR-M into a usage condition, decrypts the encrypted content key using the media ID, and obtains the content ID based on the media content ID, to create an LT (LT-In) including the usage condition, but not including the content key and the content ID. The media read unit 17 then deletes the encrypted content key in the protected area 5, to make the digital work irreproducible, and then delivers the media unique information to the Move-In control unit 16.

<PDs 4a, 4b, and 4c>

The following describes the PDs 4a, 4b and 4c. The PDs 4a, 4b, and 4c are devices that conform to the SDMI and that can write/read data in the protected area 5 in the portable medium 3 and can reproduce a digital work. The PDs 4a, 4b, and 4c are internally equipped with a secure I/O plug-in. This secure I/O plug-in includes a media read unit and a media write unit for accessing the protected area 5 in the portable medium 3, and a reproduction module. These units respectively have the same function as the media read unit 17, the media write unit 15, and the reproduction module 12 equipped in the secure I/O plug-in 10. For example, the reproduction module in the PDs 4a, 4b, and 4c, as the reproduction module 12, can decrypt encrypted content stored in the user area 6 using the content key included in the LT stored in the protected area 5, to reproduce the digital work. Here, the PDs 4a, 4b, and 4c also keep a time period during which the digital work is being reproduced, and decrements the usage count by one when the time period exceeds the usage threshold.

<Distribution Device 1>

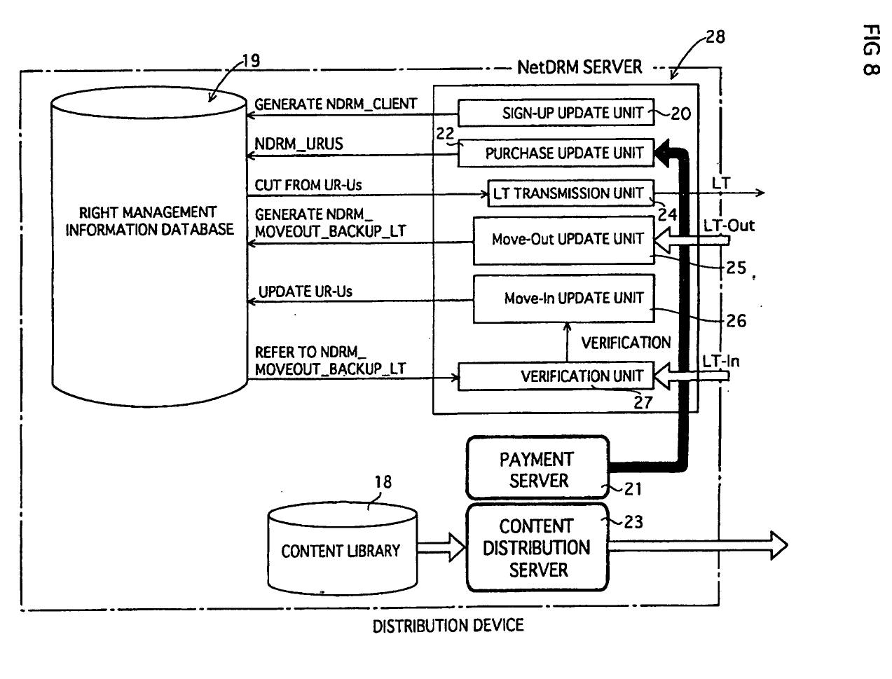

The following describes the internal structure of the distribution device 1. FIG. 8 shows the internal structure of the distribution device 1. The distribution device 1 includes a content library 18, a right management information database 19, a sign-up update unit 20, a payment server 21, a purchase update unit 22, a content distribution server 23, an LT transmission unit 24, a Move-Out update unit 25, a Move-In update unit 26, and a verification unit 27. Among these units, the sign-up update unit 20, the purchase update unit 22 and the LT transmission unit 24, the Move-Out update unit 25, the Move-In update unit 26, and the verification unit 27 constitute a NetDRM server 28.

The content library 18 stores a plurality of encrypted contents that can be distributed. These encrypted contents are each uniquely identified by a different content ID.

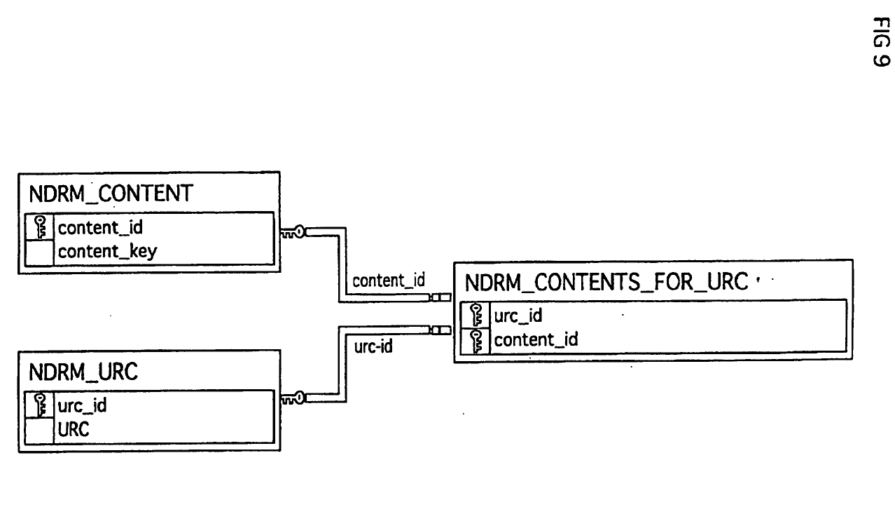

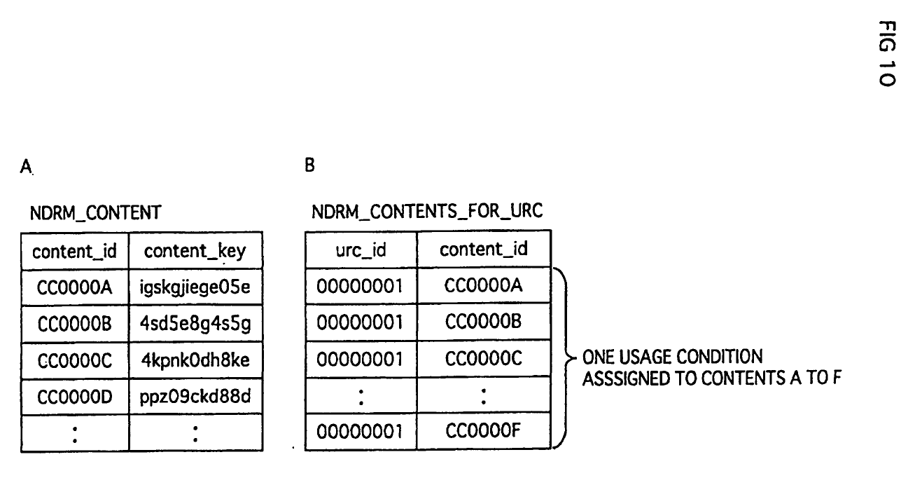

The right management information database 19 stores a content key, a content ID, and a usage condition for each digital work to be downloaded. Before a user's signing up this service, the storage content of the right management information database 19 is as shown in FIG. 9. As FIG. 9 shows, the right management information database 19 is made up of three tables: “NDRM_CONTENT”, “NDRM_URC”, and “NDRM_CONTENTS_FOR_URC”. The “NDRM_CONTENT” is a table for associating a content ID and a content key. FIG. 10A shows an example of the “NDRM_CONTENT”. AS the figure shows, contents IDs “CC0000A”, “CC0000B”, “CC0000C”, and “CC0000D” are respectively associated with content keys “jgskgjiege05e”, “4sd5e8g4s5g”, “4kpnk0dh8ke”, and “ppz09ckd88d”.

The “NDRM_URC” is a table for associating a urc_id and a UR-C. A UR-C (Usage Rule for Content) is an original version of right management information defined by a content provider, and a urc id is an identifier for the UR-C. The “NDRM_CONTENTS_FOR_URC” is a table including a plurality of pairs of urc_id and content_id, and associating the “NDRM_CONTENT” and the “NDRM_URC”. FIG. 10B shows an example of the “NDRM_CONTENTS_FOR_URC”. As the figure shows, six content IDs “CC0000A”, “CC0000B”, “CC0000C”, and “CC0000F” (these are the contents IDs for contents A to F in FIG. 3) are each associated with the urc_id “00000001”.

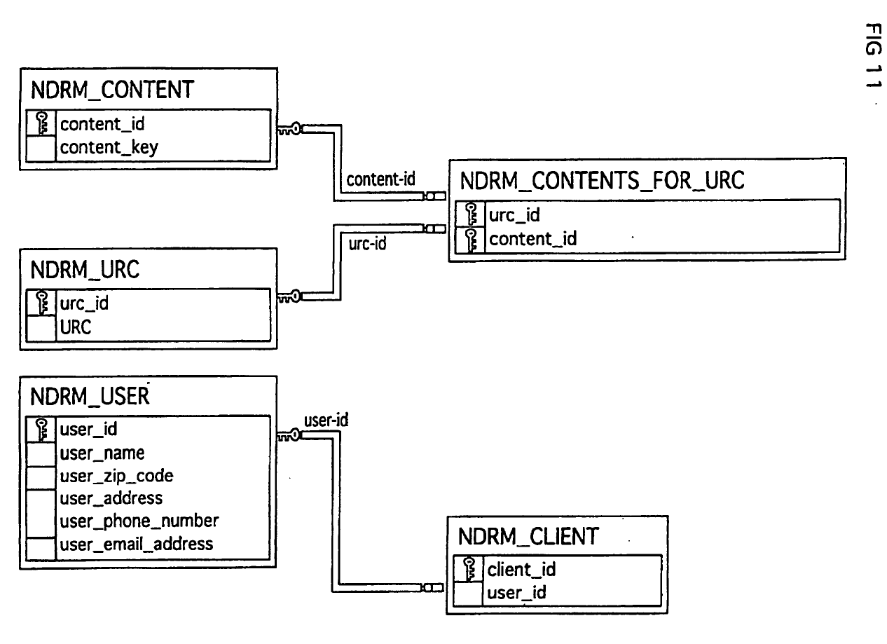

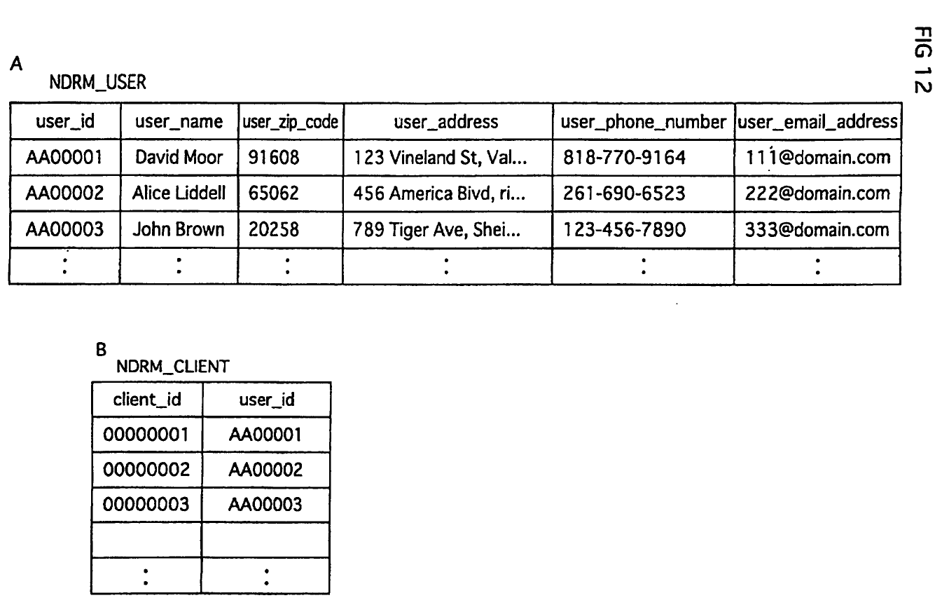

The sign-up update unit 20 registers user's ID information into the right management information database 19 in accordance with a sign-up operation by the user. The storage content of the right management information at the user's sign-up is as shown in FIG. 11. FIG. 11 shows the right management information database 19 in which the “NDRM_USER” and the “NDRM_CLIENT” have been added to that in FIG. 9. The “NDRM_USER” is ID information of the user, and is made up of the user's ID “user_id”, the user's name “user_name”, the user's zip code “user zip code”, the user's address “user_address”, the user's phone number “user_phone_number”, and the user's e-mail address “user_email_address”. When a plurality of users have signed up the service, the “NDRM_USER” is used as a template, and ID information for each of the plurality of users is managed within the right management information database 19. FIG. 12A shows ID information for each of users “David Moor”, “Alice Liddell”, and “John Brown” who have signed up the service as one example. The “NDRM_CLIENT” is made up of a user's identifier “user_id”, and an identifier “client_id” for the NetDRM client 8 in the NetDRM terminal device 2 owned by the user. FIG. 12B shows the “NDRM_CLIENT” set for three users respectively having user_ids “AA00001” to “AA00003”. In this “NDRM_CLIENT”, client_ids “00000001” to “00000003” are respectively assigned to user_ids “AA00001” to “AA00003”.

The payment server 21 handles payment via a network when the user purchases digital works.

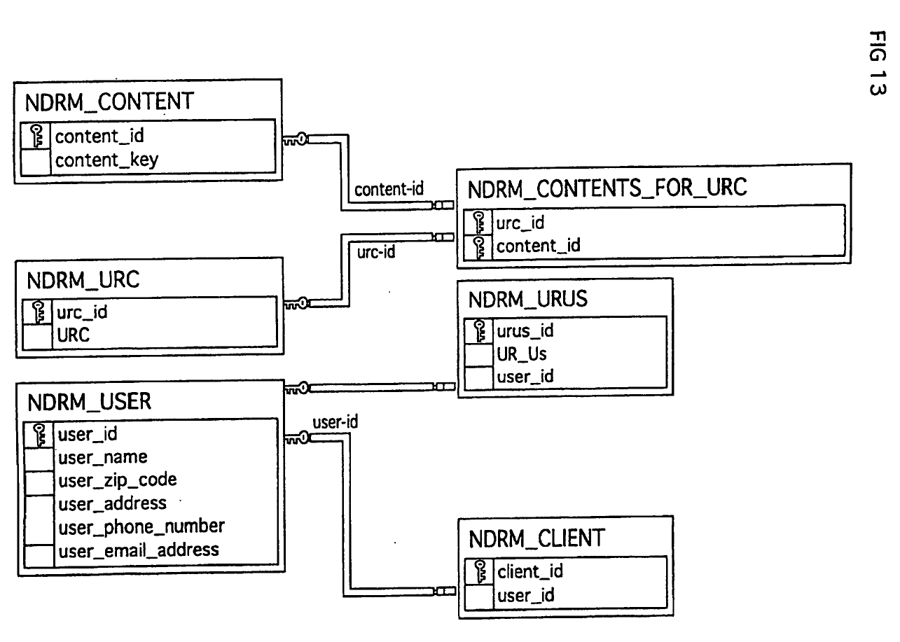

The purchase update unit 22 updates the right management information database 19 accordingly when the user purchases digital works. FIG. 13 shows the storage content of the right management information database 19 after the user has purchased digital works. As the figure shows, after the digital works have been purchased, a table “NDRM_URUS” is added to the right management information database 19. The “NDRM_URUS” is made up of a UR-Us's identifier “urus_id”, the entity of right management information assigned to the user “UR-Us (Usage Rule for User on Server)”, and the identifier of the user who has purchased the digital works “user_id”.

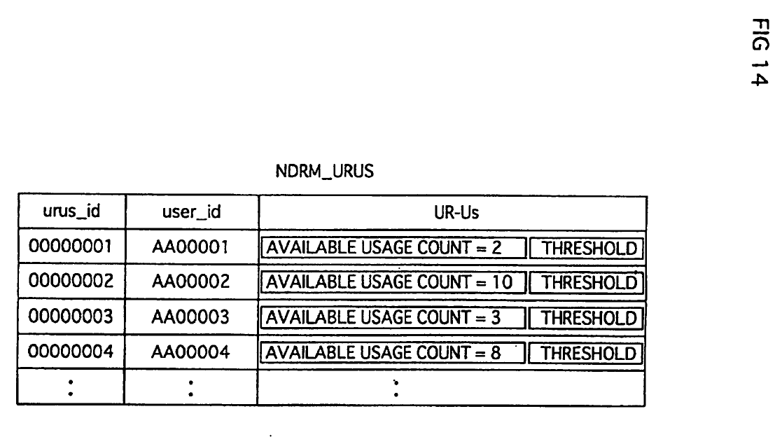

FIG. 14 shows the “NDRM_URUS” set for a plurality of users having user_ids “AA00001” to “AA00004”. As the figure shows, the UR-Us indicating the available usage count and the usage threshold is set for each user.

The content distribution server 23 transmits encrypted content, out of a plurality of encrypted contents stored in the content library 18, as requested by the user.

The LT transmission unit 24 transmits, to the user, an LT including a usage condition and a content key for the requested digital work in a digital work group designated by the user. The LT transmission unit 24 cuts out a part of the available usage condition in the UR-Us managed in the right management information database 19. The “cutting out usage condition” herein intends to mean the processing to generate information that indicates a part of the usage condition and to decrease the UR-Us in the right management information database 19. The following is the case where the UR-Us indicates the available usage count of 10 and the LT transmission unit 24 cuts a usage count of 8 from the available usage count of 10. The usage count of 8 is subtracted from the available usage count of 10 to yield an available usage count of 2.

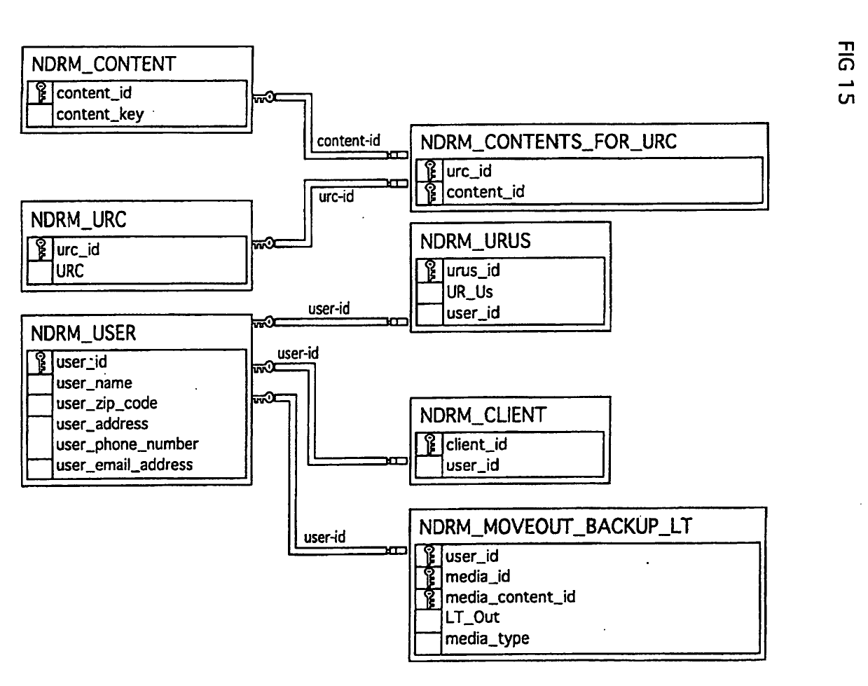

The Move-Out update unit 25 is a module used for updating the right management information database 19 when digital works are purchased. FIG. 15 shows the storage content of the right management information database 19 after Move-Out has been performed. In FIG. 15, the “NDRM_MOVEOUT_BACKUP_LT” is added to the storage content shown in FIG. 13. The “NDRM_MOVEOUT_BACKUP_LT” is made up of an identifier for the user who has performed Move-Out “user_id”, a “media_id” transmitted from the NetDRM terminal device 2 at Move-Out, a “media_content id”, an “LT-Out”, and a “media_type”.

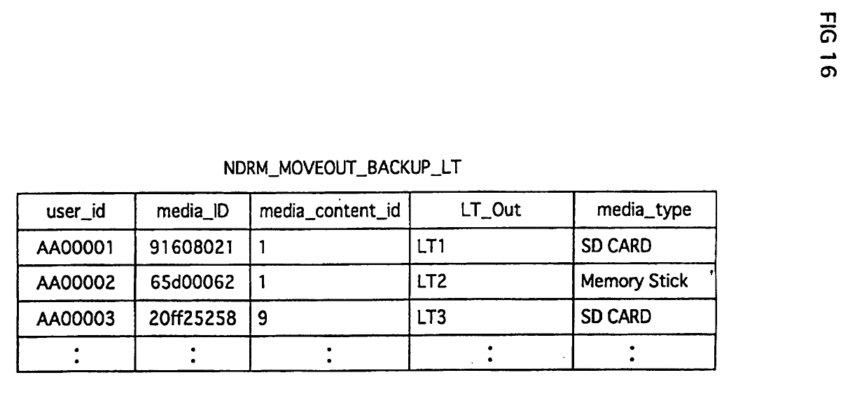

FIG. 16 shows the “NDRM_MOVEOUT_BACKUP_LT” set for a plurality of users having user_ids “AA00001” to “AA00003”. As the figure shows, a “media_ID”, a “media_content_id”, an “LT-Out”, and a “media_type” are set for each user.

The Move-In update unit 26 receives the LT transmitted from the NetDRM terminal device 2, and verifies the authenticity of the LT using a hash value stored in the LT footer of the LT, and then updates the UR-Us based on the usage condition included in this LT. As one example, when the available usage count in the UR-Us is 2, and a usage count of 6 is returned from the NetDRM terminal device 2, the Move-In update unit 26 adds the usage count of 6 to the available usage count of 2 in the UR-Us, to yield the updated available usage count of 8.

The verification unit 27 receives the media unique information of the portable medium 3 and the LT uploaded by the NetDRM terminal device 2 at Move-In, and compares the received media unique information with the media unique information stored in the “NDRM_MOVEOUT_BACKUP_LT”. Only when the comparison result shows a complete match, the verification unit 27 makes the Move-In update unit 26 update the UR-Us. When the comparison result does not show a complete match, the verification unit 27 does not make the Move-In update unit 26 update the UR-Us. In this way, the UR-Us is updated only wh n the received media unique information and the stored media unique information match completely. Therefore, a malicious user who sends an unauthorized LT to the distribution device 1, if any, fails to update the available usage count in the UR-Us and to make unfair profits.

<Operations>

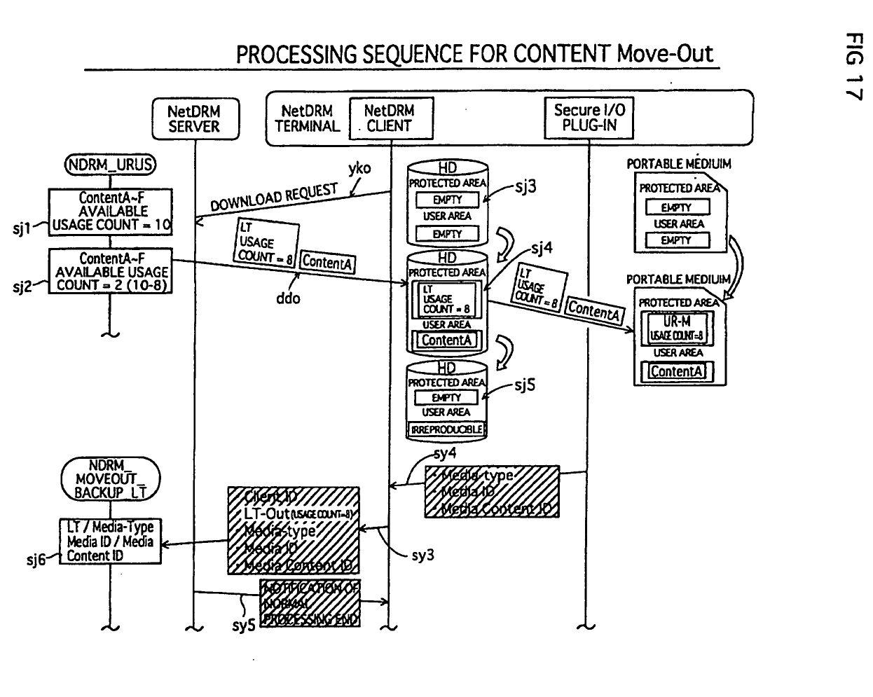

The following describes the operations of the system relating to the first embodiment described above, with reference to FIGS. 17 to 20. FIG. 17 shows a processing sequence of the system when Move-Out of content A is performed.

In FIG. 17, an initial-state sj1 indicates a state where six digital works, i.e., contents A to F, are grouped as one in the right management information database 19 and are made available to the user.

A state sj2 indicates the storage content of the UR-Us after the NetDRM client 8 issues a download request yk0 according to a download request yk1 issued by the browser. The available usage count of 2 in the UR-Us in the state sj2 is the available usage count remaining after the usage count of 8 is cut from the available usage count of 10. The cut usage count of 8 is stored in the LT and downloaded together with the encrypted content A as indicated by arrow dd0.

A state sj4 indicates the storage content of the HD 7 after the LT and the encrypted content A have been downloaded to the NetDRM client 8. To be more specific, this state sj4 indicates a state where the LT including the usage count of 8 and the encrypted content A are written to the HD 7.

In the state sj4, Move-Out of content A is assumed to be initiated. The LT and the encrypted content A stored in the HD 7 are delivered to the secure I/O plug-in 10. A state sj5 indicates the storage content of the HD 7 after the LT and content A have been delivered, and indicates that the encrypted content A has been converted into an irreproducible state and the LT has been deleted.

A state sj6 indicates the storage content of the “NDRM_MOVEOUT_BACKUP_LT” in the right management information database 19 after Move-Out has been performed in the NetDRM terminal device 2. In the “NDRM_MOVEOUT_BACKUP_LT”, the media unique information and the LT uploaded from the secure I/O plug-in 10 and the NetDRM client 8 are stored as indicated by arrows sy3 and sy4. In the state sj6, notification of normal processing end is transmitted by the distribution device 1 as indicated by arrow sy5. The NetDRM client 8 receives this notification, and ends Move-Out.

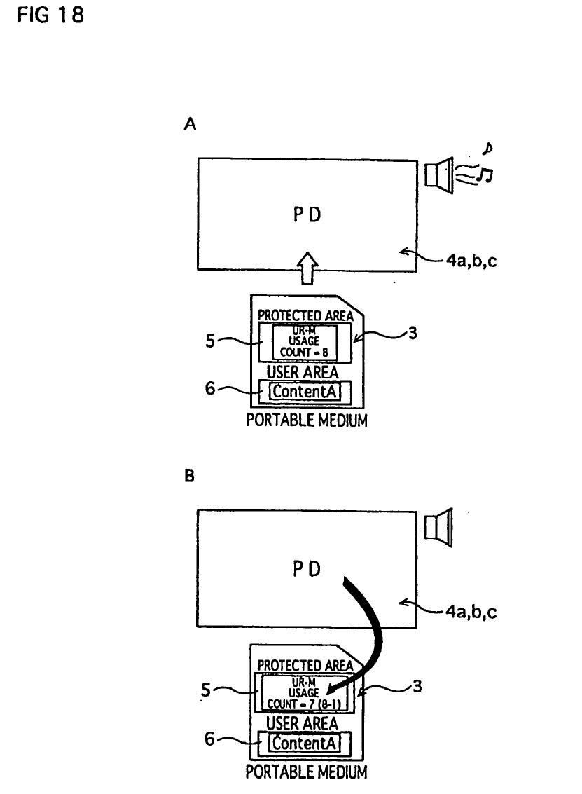

FIGS. 18A and 18B show how the portable medium 3 to which content A has been written is used. Assume that the user mounts the portable medium 3 to which content A has been written by Move-Out, upon the PDs 4a, 4b, or 4c and reproduces content A as shown in FIG. 18A. FIG. 18B shows the portable medium 3 to which content A has been written by Move-Out. In this state, because content A has been reproduced once by the PDs 4a, 4b, or 4c, a usage count of 1 is subtracted from the usage count of 8, to yield the remaining usage count of 7.

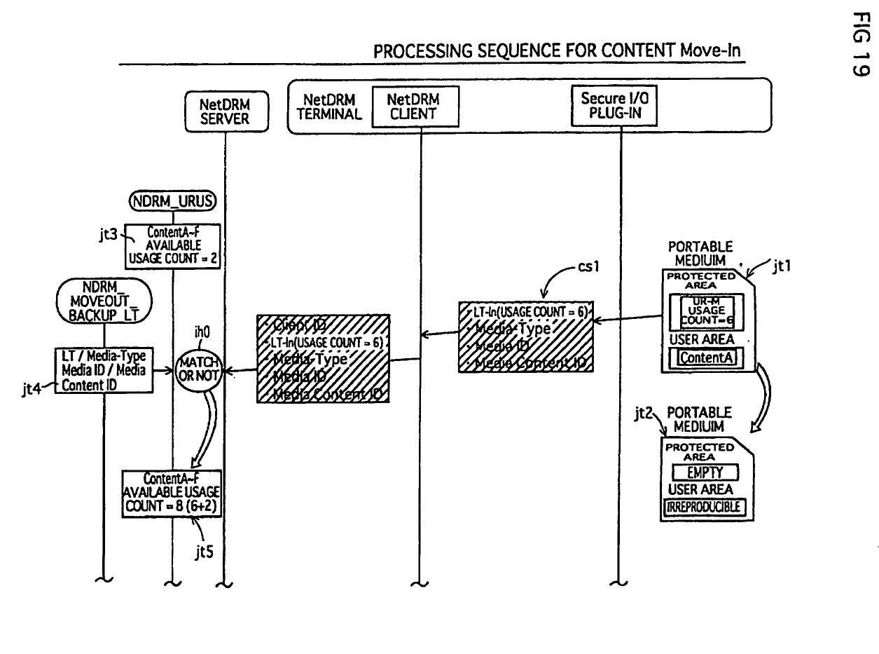

Assume that the user connects the portable medium 3 again to the NetDRM terminal device 2 after repeatedly reproducing content A. FIG. 19 shows a processing sequence of the system when Move-In of content A is performed. A state jt1 indicates the storage content of the portable medium 3 after the reproduction has been performed twice. As the figure shows, the usage count in the protected area 5 is 6 (=8-2). Assume that Move-In is then performed from the portable medium 3. A state jt2 indicates the storage content of the portable medium 3 after Move-In has been performed. The UR-M in the protected area 5 of the portable medium 3 has been deleted, and the encrypted content is in an irreproducible state. Transmission cs1 of the LT and the media unique information is performed between the state jt1 and the state jt2.

A state jt3 indicates the “NDRM_URUS” before Move-In is performed to the NetDRM terminal device 2. The usage count is 2 in this state. A state jt4 indicates the storage content of the “NDRM_MOVEOUT_BACKUP_LT” after the LT and the media unique information have been uploaded. This storage content is used for judgment ih0 for verifying the authenticity of the media unique information delivered to the distribution device 1 by the transmission cs1.

A state jt5 indicates the storage content of the “NDRM_URUS” that is updated after the media uniqu information has been verified. In this state, the usage count is 8, yielded by adding the remaining usage count of 6 to the available usage count of 2 indicated by the state jt3.

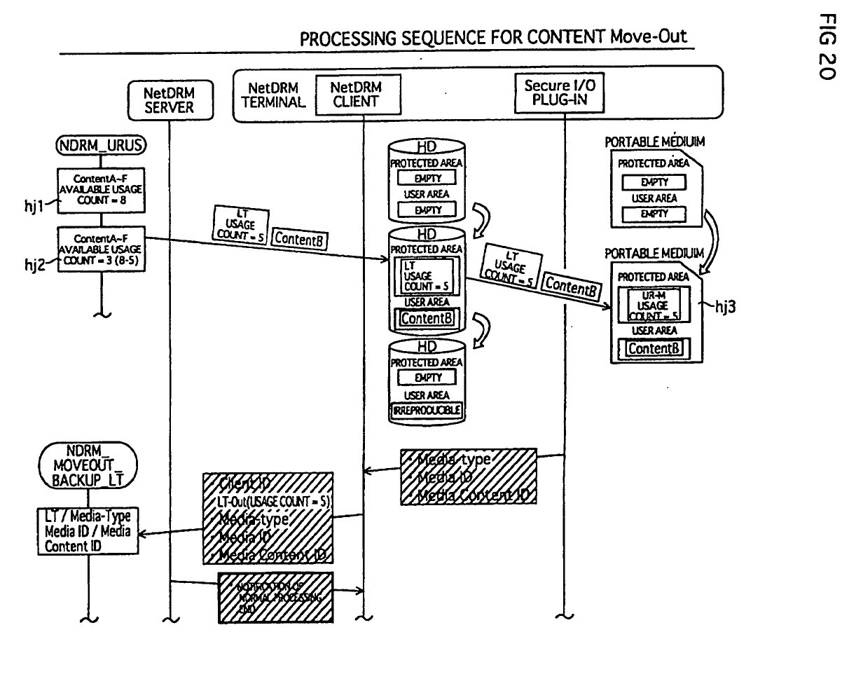

FIG. 20 shows a processing sequence of the system when Move-Out of content B is performed. A state hj1 in FIG. 20 indicates the storage content of the “NDRM_URUS” before content B is downloaded. Move-In shown in FIG. 19 results in the available usage count being increased to 8. Therefore, a usage count of 1 to 8 can be allocated to content B. A state hj2 indicates the storage content of the “NDRM_URUS” after content B has been downloaded. A usage count of 5 has been allocated to content B, and so the available usage count is updated to be 3 (=8−5).

A state hj3 indicates the storage content of the portable medium 3 after Move-Out of content B has been performed. Because encrypted content delivered to the secure I/O plug-in 10 by transmission and the usage count of 5 are written to the portable medium 3, the digital work can be used five times at most.

Assume that the user downloads a digital work with the intention of using it ten times but no longer wants the digital work after listening to it twice. In this case, the remaining usage count of 8 is written into the protected area 5 of the portable medium 3, and this remaining usage count is also uploaded to the distribution device 1 by the NetDRM terminal device 2. Then, this usage count 8 can be allocated to different digital works in the same group.

As described above, the present embodiment realizes the service enabling the user to freely download digital works in a group and use the digital works within a predetermined available usage count, thereby increasing customer satisfaction. Also, because the transmission device manages right management information of digital works and usage records, novel services can be expected, such as a discount service in accordance with the number of download times, or a free service to a user who uses a specific device.

Note that although the present embodiment has been described assuming a digital work as a music work, the digital work may be a video work such as an electronic book, a movie, and a TV drama, a still image, or an application program such as game software.

(Second Embodiment)

Although a usage count is used as the usage condition of a digital work in the first embodiment, a usage time period is used as the usage condition in the second embodiment.

As in the case of the usage count, the usage time period that is the usage condition is subjected to various operations performed by the distribution device 1, the NetDRM terminal device 2, and the PDs 4a, 4b, and 4c.

First, the available usage count is written in the UR-Us and its part can be cut out at the time of downloading a digital work in the first embodiment. In the same way, the available usage time period used as the usage condition in the present embodiment is also written in the UR-Us and its part can be cut out. As one example, when the available usage time period of 60 minutes is written in the UR-Us, a usage time period of 0 to 60 minutes can be cut out.

Second, a usage count downloaded together with encrypted content is written to the HD 7 in the NetDRM terminal device 2 or to the portable medium 3 and the encrypted content can be used until the usage count reaches zero in the first embodiment. The same applies to the usage time period in the present embodiment. To be more specific, a usage time period downloaded together with encrypted content is written to the HD 7 in the NetDRM terminal device 2 or to the portable medium 3, and the encrypted content can be used until the usage time period reaches zero.

Third, a usage count is decremented by one every time when encrypted content is used once in the first embodiment. The same applies to the usage time period in the present embodiment. To be more specific, a usage time period downloaded together with encrypted content is reduced by a tim period during which the encrypted content is being us d every time when the encrypted content is used once.

Fourth, a remaining usage count can be added to the UR-Us in the distribution device 1 by uploading it from the NetDRM terminal device 2 to the distribution device 1 in the first embodiment. The same applies to the usage time period in the present embodiment. To be more specific, a remaining usage time period can be added to the available usage time period written in the UR-Us by uploading it from the NetDRM terminal device 2 to the distribution device 1.

The usage time period added in this way can be re-allocated to a different content.

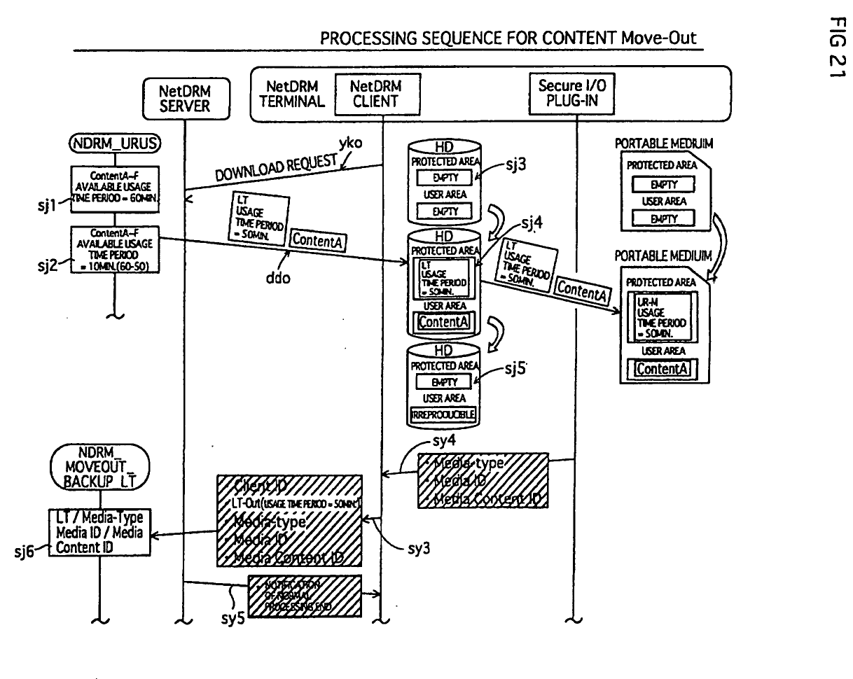

FIGS. 21 to 23 show operation examples of the system using the usage time period as the usage condition. The operation examples shown in these figures include the same states as shown in FIGS. 17 to 19. The only difference is that usage counts of 10, 8, 7, etc. in the states shown in FIGS. 17 to 19 are replaced with usage time periods of 60 minutes, 50 minutes, 10 minutes, etc. in FIGS. 21 to 23.

The following describes the operation examples in FIGS. 21 to 23. FIG. 21 shows the operation to cut a usage time period of 50 minutes from the available usage time period of 60 minutes in the UR-Us (state sj1) and download, and write the usage time period of 50 minutes to the portable medium 3 togeth r with content A.

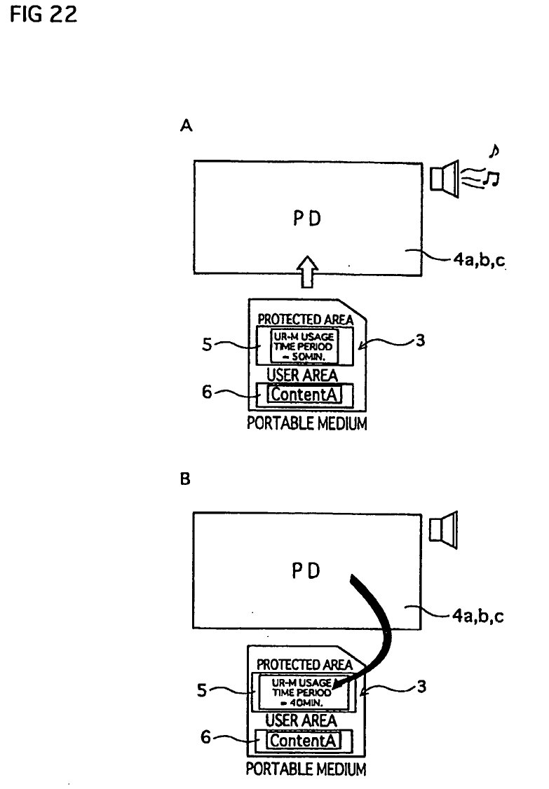

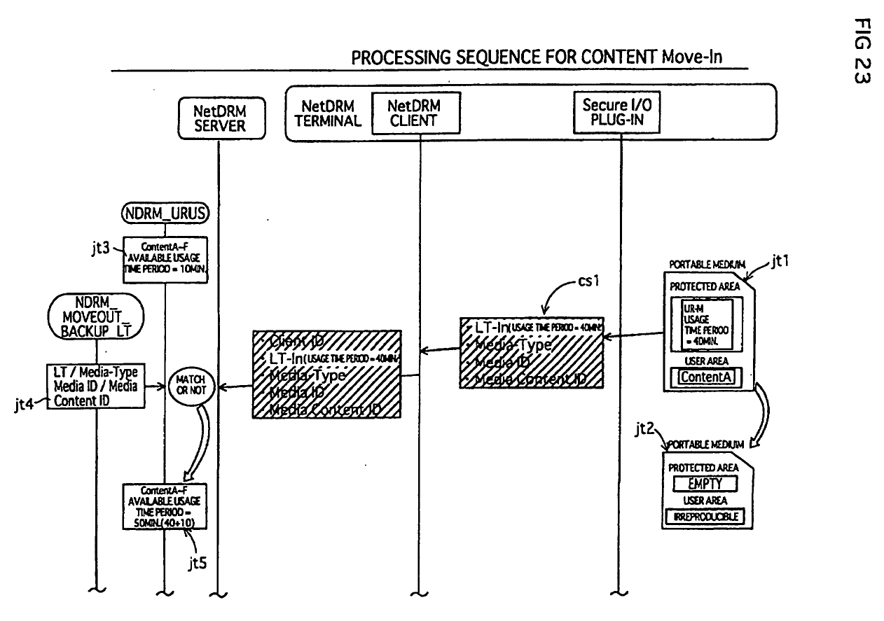

FIGS. 22A and 22B indicate how the usage time period in the portable medium 3 is reduced to 40 minutes after content A was reproduced for 10 minutes. FIG. 23 indicates how the remaining usage time period of 40 minutes is uploaded to the distribution device 1 and added to the UR-Us in the distribution device 1. The operation described above results in the available usage time period of 10 minutes managed by the distribution device 1 being increased to 50 minutes. Due to this, a usage time period of 1 to 50 minutes can be allocated to a different digital work of content B.

As described above, the present embodiment enables a usage time period to be allocated freely to each content when content usage is managed by a usage time period.

Note that although a usage time period is updated by minute in the present embodiment, it may be updated by hour or by second.

(Third Embodiment)

Although the first and second embodiments limit usage action of a digital work to reproduction, the present embodiment assumes that a plurality of usage actions such as reproduction and printing are available.

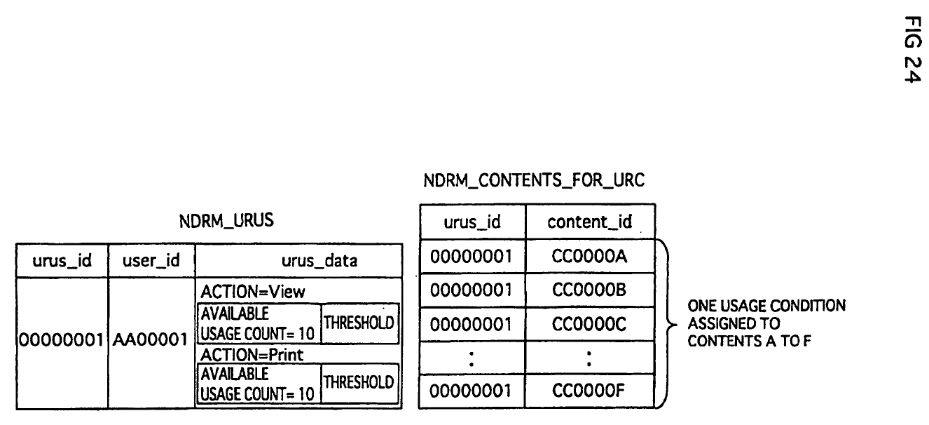

FIG. 24 shows an example of right management information (UR-Us) having a usage condition for each usage action such as reproduction and printing. When a digital work is an electronic book, the action “view” in the figure indicates to view the electronic book. The action “print” indicates to print out the electronic book. The UR-Us in FIG. 24 sets an available usage count and a usage threshold for each of the actions “view” and “print”. That is to say, an independent usage condition is defined for each of the actions for one digital work. Also, when a digital music work is attached with an image such as a score, a background image, and a star's picture, the usage condition can be set specially for such an image. That is to say, an available usage count or usage time period can be allocated for an action of viewing or printing out such an image.

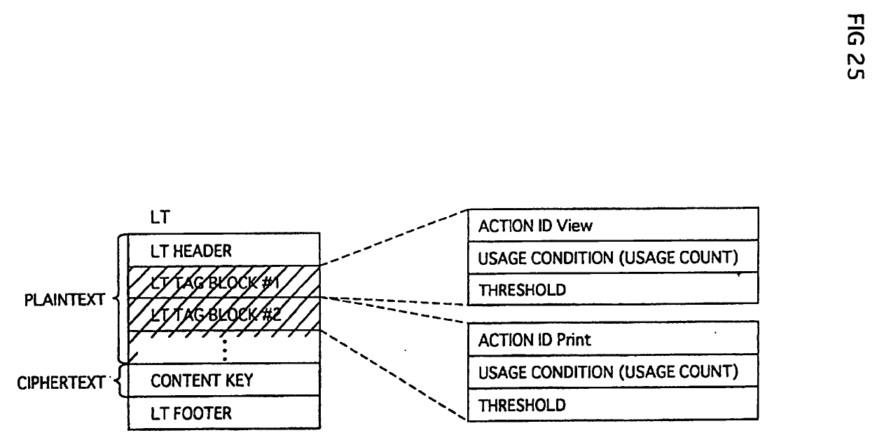

Usage conditions for a plurality of usage actions are transmitted with being included in an LT having the data format shown in FIG. 25. FIG. 25 shows the data format of an LT including a plurality of LT tag blocks. The LT tag block #1 shown in FIG. 25 stores an action ID indicating the action “view”, a usage count and a usage threshold for the action “view”. The LT tag block #2 stores an action ID indicating the action “print”, a usage count and a usage threshold for the action “print”.

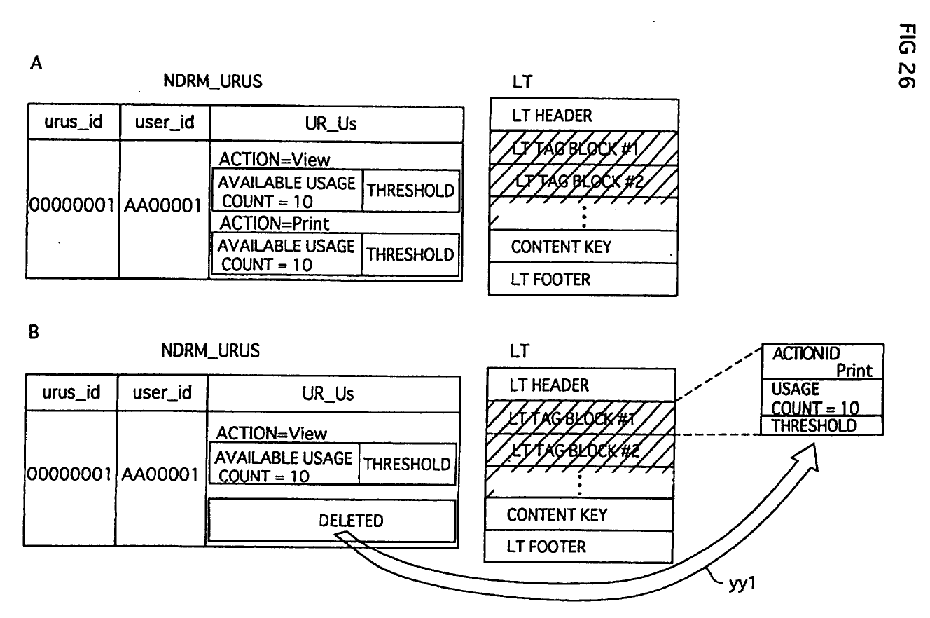

The following describes how the usage condition is cut out in the third embodiment, with reference to FIGS. 26A and 26B. FIG. 26A shows the UR-Us before the usage condition is cut out, whereas FIG. 26B shows the UR-Us after the usage condition has been cut out. The UR-Us in FIG. 26A includes two pairs of available usage count of 10 and usag threshold. One pair shows the usage count of 10 and the threshold for the action “view”, and the other pair for the action “print”. When the usage count of 10 for the action “print” is cut from this UR-Us as indicated by arrow yy1 and is transmitted with being included in an LT, the usage condition for the action “print” is completely deleted from the UR-Us. The usage count of 10 is stored in the LT tag block together with the action ID indicating the action “print” and the usage threshold. Here, the usage condition for the action “view” is kept intact in the UR-Us, and this usage condition can be downloaded together with another content at the next download. As the figure shows, when the digital work is downloaded, the usage condition of one or both actions can be cut out.

On the other hand, receiving the LT in which the usage condition is set for each action, the NetDRM terminal device 2 cuts out only the usage condition acceptable to the PDs 4a, 4b, or 4c and converts it into UR-M. This is because the capability for using a digital work varies depending on each of the PDs 4a, 4b, and 4c. For example, one may be a PDA and can be used to view the digital work but cannot be used to print out the digital work, or another may be used to both view and print out the digital work. Accordingly, all usage conditions for the digital work may not be acceptable to each device. For this reason, only the usage condition acceptable to the PDs 4a, 4b, or 4c is cut out.

As described above, the present embodiment enables the usage condition to be set for each usage action of a digital work to be downloaded, when a plurality of usage actions such as printing or viewing are available on a device such as an electronic book.

(Fourth Embodiment)

In the fourth embodiment, a usage condition called “P (Plug-in) condition” is additionally provided. The usage condition employed in the first to third embodiments can be applied to any usage action. The usage condition of this kind is called C (Client) condition. On the other hand, P-condition depends on a usage action. That is to say, P-condition imposes limitations upon the usage action itself performed by the user on his or her device. To be more specific, when a digital work includes audio, C-condition limits the usage count for the usage action of reproduction. On the other hand, P-condition limits the usage action itself of one count. For example, P-condition specifies reproduction quality.

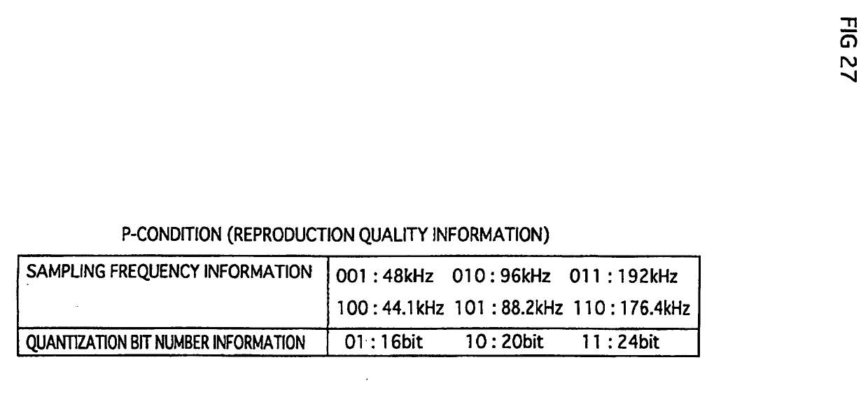

FIG. 27 shows an example of P-condition set for a digital work that includes audio. In the figure, the P-condition specifies reproduction quality of the digital work using parameters such as sampling frequency information and quantization bit number information.

The sampling frequency information is for instructing the secure I/O plug-in 10 to perform reproduction with a sampling frequency of one of 48 kHz, 96 kHz, 192 kHz, 44.1 kHz, 88.2 kHz, and 176.4 kHz by designating a value out of values 001 to 110 in the figure. The quantization bit number information is for instructing the secure I/O plug-in 10 to perform reproduction with a quantization bit number of one of 16 bits, 20 bits, and 24 bits by designating a value out of values 01 to 11 in the figure.

The sampling frequency or the quantization bit number respectively indicated by the sampling frequency information and the quantization bit number information greatly affect reproduction quality of a digital work. Therefore, the reproduction quality of the digital work can be controlled by thee PDs 4a, 4b, and 4c, and the NetDRM terminal device 2 performing reproduction in accordance with the limitation imposed by the P-condition. Because P-condition is a usage condition that limits a usage action itself, it can be set suitably for the digital work. For example, when the digital work is a movie, the image quality (resolution) may be set suitably, or when the digital work is an electronic book, the print type (color or monochrome) may be set suitably.

Furthermore, P-condition can be set according to a type of the portable medium 3 to which the digital work is to be written. For example, when th portable medium 3 is an SD memory card, the P-condition may be set so as to limit functions unique to the SD memory card (edit operations such as partial deletion, division, and integration, or special reproduction such as rapid-reproduction and random reproduction). When the portable medium 3 is a memory stick, the P-condition may be set so as to limit functions unique to the memory card.

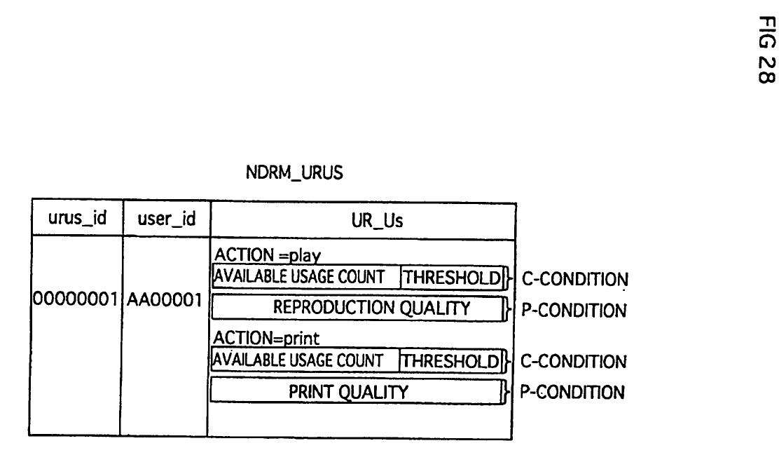

An example of right management information employed in the forth embodiment is shown in FIG. 28. FIG. 28 shows the example where a plurality of usage actions such as viewing and printing are available, and C-condition and P-condition are set for each usage action. To be more specific, the UR-Us in the figure includes C-condition and P-condition set for each usage action, i.e., “play” and “print”. For the action “play”, the P-condition indicates reproduction quality. For the action “print”, the P-condition indicates printing grade.

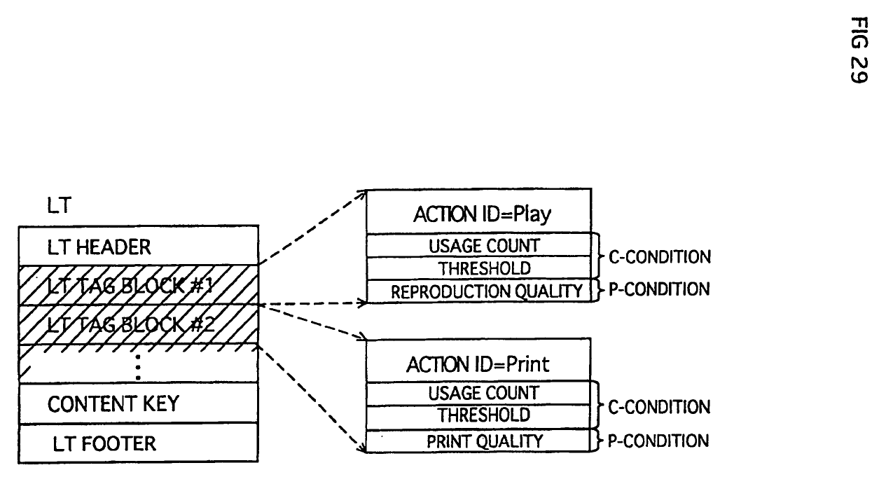

To transmit the usage condition for a plurality of usage actions, the P-condition for each usage action is distributed with being included in an LT having the data format shown in FIG. 29. The LT tag block #1 stores the P-condition defining an action ID indicating the usage action “play”, an available usage count and a usage threshold for the usage action “play”, and the reproduction quality. On the other hand, the LT tag block #2 stores the P-condition defining an action ID indicating the usage action “print”, an available usage count and a usage threshold for the usag action “print”, and the printing grade.

Because the P-condition is transmitted together with the C-condition, the usage condition that combines the usage count and the usage time period indicated by the C-condition with the reproduction quality indicated by the P-condition can be realized. That is to say, the following limitations may be imposed upon the PDs 4a, 4b, and 4c and the NetDRM terminal device 2. When the reproduction quality of usage action of one count is favorable, the usage count can be reduced, or when the reproduction quality of usage action of one count is unfavorable, the usage count can be made unlimited.

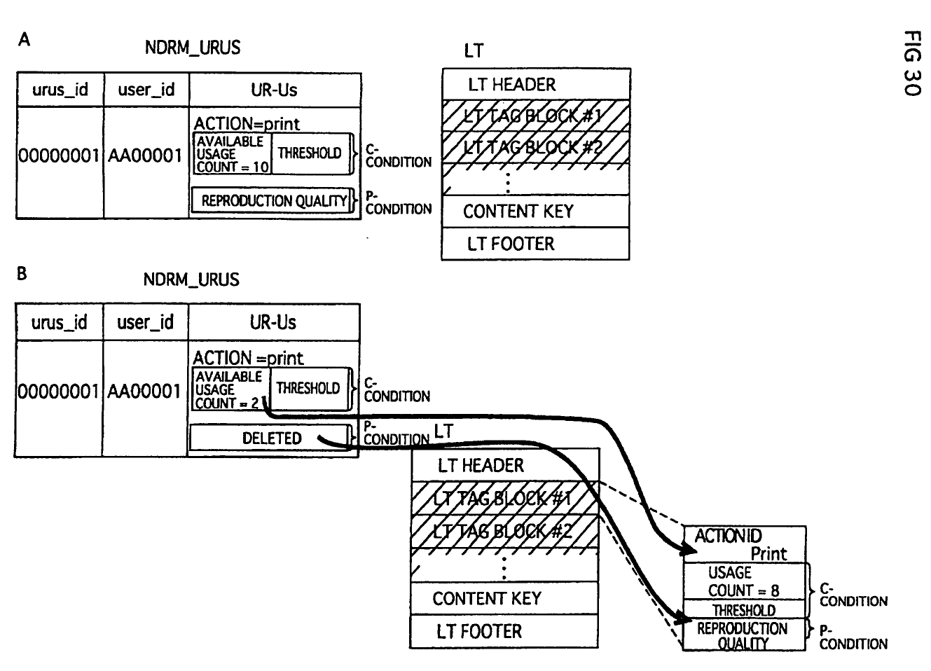

The following describes how a usage condition is cut out in the fourth embodiment, with reference to FIGS. 30A and 30B. FIG. 30A shows the UR-Us before the usage condition is cut out, whereas FIG. 30B shows the UR-Us after the usage condition has been cut out. The “NDRM_URUS” includes C-condition that is made up of an available usage count of 10 and a usage threshold, and P-condition that indicates the reproduction quality. When a usage count of 8 and the reproduction quality have been cut from this UR-Us and downloaded to the NetDRM terminal device 2, the usage condition for the usage action “print” shows a remaining available usage count of 2, yielded by subtracting the usage count of 8 from the available usage count of 10 in the UR-Us, and also the reproduction quality is deleted from the UR-Us. On the other hand, the usage count of 8 is stored in the LT tag block together with the action ID indicating the usage action “print” and the usage threshold.

The P-condition stored in the LT is downloaded to the user's NetDRM terminal device 2. As in the case of the C-condition, the P-condition can be written to the portable medium 3 by Move-Out. Also, the P-condition can be uploaded to the distribution device 1 together with the C-condition by Move-In.

As described above, the present embodiment enables a usage condition to be set suitable for a type of a digital work or a type of the portable medium 3, and the PDs, 4a, 4b, and 4c to which the digital work is to be written, thereby increasing user-friendliness.

(Fifth Embodiment)

In the fifth embodiment, the number of times a digital work can be used concurrently by a plurality of devices (hereafter referred to as the “available concurrent usage count”) is managed by the distribution device 1. The available concurrent usage count managed by the distribution server 1 is called S (server) condition, which is differentiated from P-condition and C-condition. The available concurrent usage count that corresponds to S-condition is decremented when a digital work is downloaded. That is to say, every time a digital work in the group is downloaded, the available concurrent usage count that is S-condition is decremented.

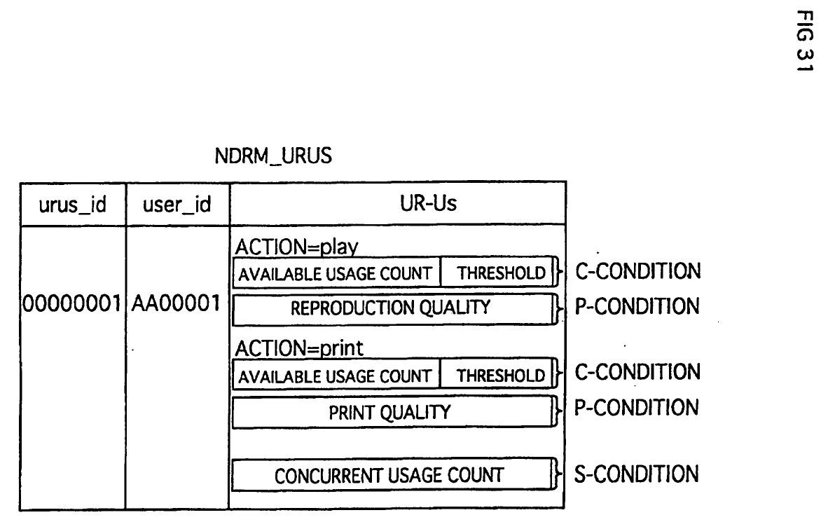

FIG. 31 shows an example of the UR-Us in which S-condition is set. In the figure, C-condition and P-condition for the usage action “play”, and C-condition and P-condition for the usage action “print” are present. In this point, the UR-Us in the figure is the same as the UR-Us in FIG. 28. In FIG. 31, however, the available concurrent usage count, S-condition, is additionally set. As can be seen from the figure, C-condition and P-condition are set for each usage action, whereas S-condition is set for each user, regardless of the available usage actions.

S-condition is decremented when an LT is downloaded. That is to say, every time when a digital work is downloaded, the available concurrent usage count is decremented.

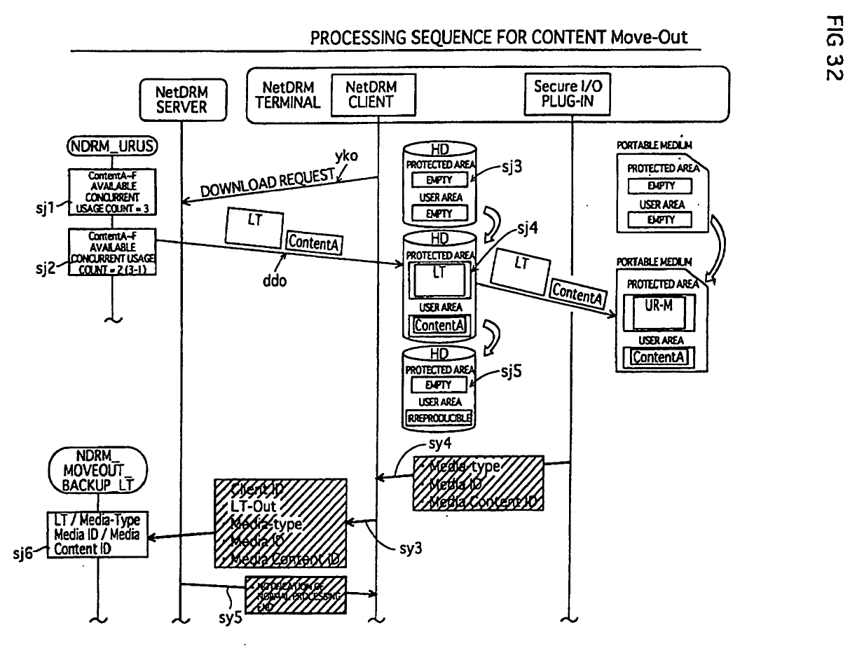

Assume that S-condition set in the UR-Us for one user indicates an available concurrent usage count of 3. In this case, if content A is downloaded, the available concurrent usage count of 3 is decremented by 1, to become 2. If two digital works, contents B and C, are then downloaded, the available concurrent usage count of 2 is decremented by 2, to become 0. Instead of downloading three digital works, for example, the user who has three NetDRM terminal devices 2 may download content A using these three NetDRM terminal devic s 2. In this case, too, the available concurrent usage count of 3, the S-condition in the UR-Us, is decremented by 3, to become 0. FIG. 32 shows how the available concurrent usage count is updated when download or Move-Out of content is performed, described in the same manner as in FIG. 17. In FIG. 32, content A is downloaded once, and so the available concurrent usage count of 3 is decremented by 1, to become 2.

On the contrary, the S-condition is incremented when an LT is uploaded. That is to say, every time a digital work is uploaded by Put-LT or Move-In, the available concurrent usage count is incremented. Here, the following two cases can be considered. In one case, three contents A, B, and C are downloaded, and so the available concurrent usage count has become 0. Three LTs for contents A, B, and C are then uploaded from the NetDRM terminal device 2. The S-condition is incremented by 3, and returns to 3. In the other case, content A is downloaded three times, and so the available concurrent usage count has become 0. Put-LT or Move-In is then performed by three NetDRM terminal devices 2 and its LT is uploaded three times. The S-condition is incremented by 3 and returns to 3.

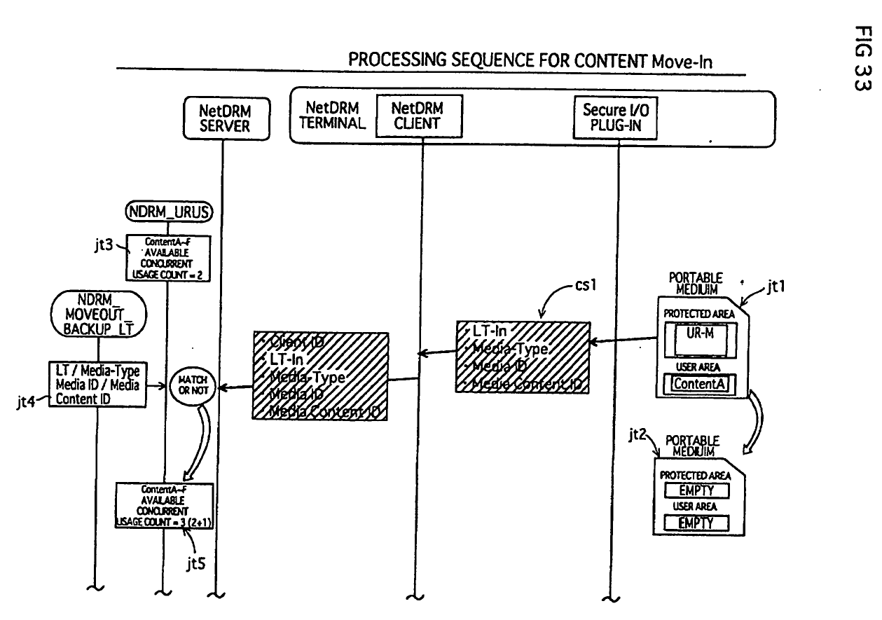

FIG. 33 shows how the available concurrent usage count is updated when Move-In of content is performed, described in the same manner as in FIG. 19.

The user can use download d three digital works on his or her the NetDRM terminal device 2 and the PDs 4a, 4b, and 4c. When C-condition and P-condition are set in the UR-Us, usage of these digital works on the NetDRM terminal device 2 is of course limited by the C-condition and the P-condition. If the C-condition and the P-condition show unlimited usage, the user can freely use the digital works on the NetDRM terminal device 2 and the PDs 4a, 4b, and 4c.

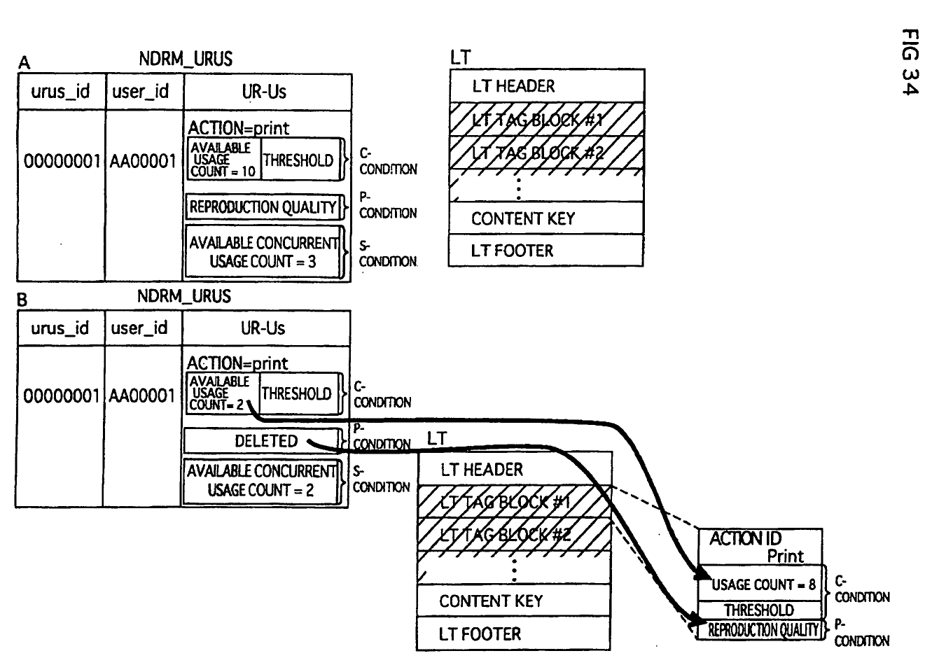

The following describes how a usage condition is cut out in the fifth embodiment, with reference to FIGS. 34A and 34B. FIG. 34A shows the UR-Us before the usage condition is cut out, whereas FIG. 34B shows the UR-Us after the usage condition has been cut out. The “NDRM_URUS” includes C-condition that is made up of an available usage count of 10 and a usage threshold, P-condition indicating reproduction quality, and S-condition indicating an available concurrent usage count of 3. If a usage count of 8 (C-condition), and the reproduction quality are cut from this UR-Us, the resulting usage condition for the usage action “print” indicates an available usage count of 2 yielded by subtracting the usage count of 8 from the available usage count of 10 in the UR-Us, and the reproduction quality is deleted from the UR-Us. The available concurrent usage count of 3 is then decremented to 2.

The following describes the operation procedure of the distribution device 1, the NetDRM client 8, and the secure I/O plug-in 10 in the system relating to the fifth embodiment, with reference to flowcharts. Because the fifth embodiment is based on the technical features of the first to fourth embodiments, the following flowcharts can be considered as a comprehensive compilation of the distribution device 1, NetDRM client 8, and secure I/O plug-in 10 disclosed in the above embodiments.

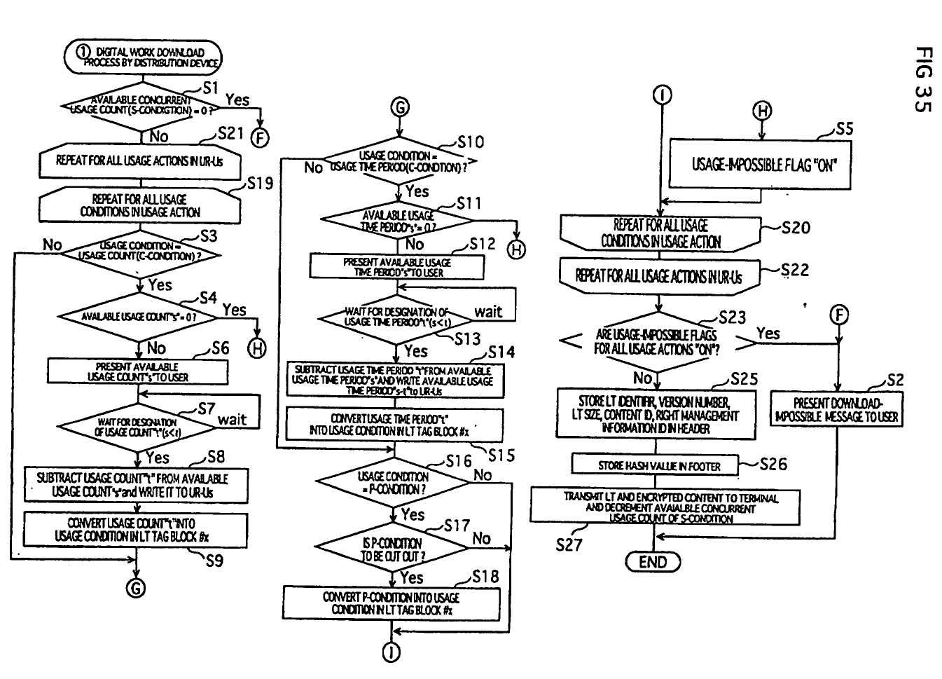

The following describes a digital work download process performed by the distribution device 1, with reference to a flowchart in FIG. 35. FIG. 35 is a flowchart showing the operation procedure of the LT transmission unit 24 relating to the fifth embodiment.

In step S1, the LT transmission unit 24 judges whether the available concurrent usage count (S-condition) is 0 or not. When download has already been performed several times and the available concurrent usage count is 0, the LT transmission unit 24 presents a download-impossible message to the user in step S2. When the available concurrent usage is not 0, the LT transmission unit 24 executes a dual-loop process. This process has a dual-loop structure in which the processing from step 3 to step S17 is repeated for each usage condition in the UR-Us (steps S19 and S20), and then for each usage action in the UR-Us (steps S21 and S22). The following describes this processing assumed to be executed for one usage condition for one usage action.

In step S3, the LT transmission unit 24 judges whether the usage condition is a usage count (C-condition) or not. When this judgment is affirmative, the LT transmission unit 24 judges whether the available usage count is 0 or not in step S4. When the available usage count is 0, the usage action is not executable. Therefore, the LT transmission unit 24 sets a usage-impossible flag “ON”, indicating that the usage action is impossible, in step S5. When the available usage count is not 0, the LT transmission unit 24 presents the available usage count “s” to the user in step S6, and waits for the user to designate a usage count “t” (s>t) in step S7.

When the usage count “t” is designated, the LT transmission unit 24 subtracts the usage count “t” from the available usage count “s”, and writes the remaining usage count “s−t” as the available usage count into the UR-Us in step S8. The LT transmission unit 24 then converts the usage count “t” into the usage condition in the LT tag block #x in step S9.

In step S10, the LT transmission unit 24 judges whether the usage condition is a usage time period (C-condition) or not. When the judgment result is affirmative, the LT transmission unit 24 judges whether the available usage time period “s” is 0 or not in step S11. When the available usage time period is 0, the usage action is not executable. Therefore, the LT transmission unit 24 sets the usage-impossible flag “ON”, indicating that the usage action is impossible, in step S5. When the available usage time period is not 0, the LT transmission unit 24 presents the available usage time period “s” to the user in step S12, and waits for the user to designate a usage time period “t” (s >t) in step S13. Following this, the LT transmission unit 24 subtracts the usage time period “t” from the available usage time period “s”, and writes the remaining usage time period “s−t” as the available usage time into the UR-Us in step S14. The LT transmission unit 24 then converts the usage time period “t” into the usage condition in the LT tag block #x in step S15.

In step S16, the LT transmission unit 24 judges whether the usage condition is P-condition or not. When this judgment result is affirmative, the LT transmission unit 24 receives a user designation as to whether the P-condition is to be cut out or not in step S17. When the user designates the cut-out, the LT transmission unit 24 converts the P-condition into the usage condition in the LT tag block #x in step S18. When the above described processing is executed for all usage conditions for all usage actions, the processing advances to step S23. In step S23, the LT transmission unit 24 judges whether the usage-impossible flags for all usage actions are “ON” or not. When the usage-impossible flags for all usage actions are “ON”, the LT transmission unit 24 presents a download-impossible message to the user in step S2. When the usage-impossible flag for at least one usage action is “OFF”, the LT transmission unit 24 stores an LT identifier, a version number, an LT size, a content ID, and a right management information ID into the LT header of the LT in step S25, and stores a hash value into the LT footer of the LT in step S26, and transmits the LT in step S27. Also, the LT transmission unit 24 instructs the content distribution server 23 to download the encrypted content.

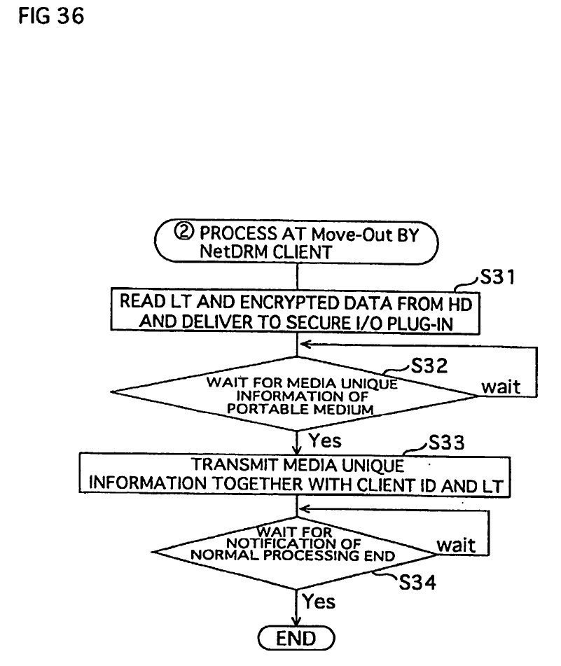

The LT and the encrypted content are transmitted by the above described procedure, and then the NetDRM client 8 stores the transmitted LT and encrypted content in the HD 7. After that, when Move-Out of the LT and encrypted content is performed, the NetDRM client 8 executes the operation procedure according to a flowchart in FIG. 36.

FIG. 36 is a flowchart showing the operation procedure of the Move-Out control unit 14.

In step S31, the Move-Out control unit 14 reads the LT and the encrypted content from the HD 7, and delivers the LT and the encrypted content to the secure I/O plug-in 10. In step S32, the Move-Out control unit 14 waits for media unique information of the portable medium 3. Upon receipt of the media unique information, the Move-Out control unit 14 transmits the media unique information to the distribution device 1 together with the client ID and the LT in step S33. In step S34, the Move-Out control unit 14 waits for notification of normal processing end. On receipt of this notification, the Move-Out control unit 14 ends the processing.

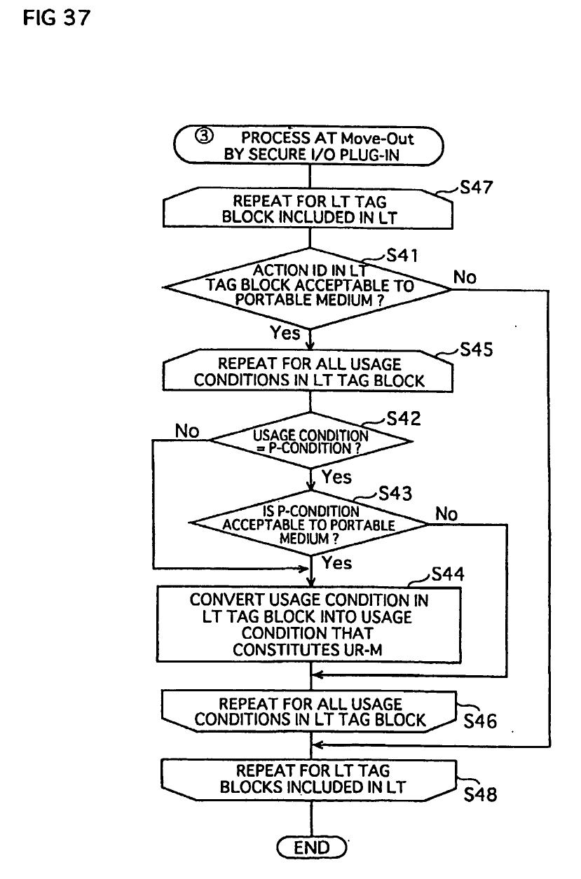

The following describes the operation procedure of the secure I/O plug-in 10 when Move-Out is performed, with reference to a flowchart in FIG. 37. FIG. 37 is a flowchart showing the operation procedure of the media write unit 15 in the secure I/O plug-in 10. The flowchart in FIG. 37 shows a loop process in which the processing from steps S41 to S46 is repeated for each LT tag block included in the LT (steps S47 and S48). In step S41, the media write unit 15 judges whether an action ID in an LT tag block is acceptable to the PDs 4a, 4b, and 4c owned by the user. When the PDs 4a, 4b, and 4c do not have printing and display functions and only have audio reproduction function, the processing from steps S42 to S46 is executed only for such LT tag blocks in which an action ID indicates audio, and the processing from steps S42 to S46 is skipped for the other LT tag blocks.

Steps S45 and S46 indicate a loop process in which the processing from steps S42 to S44 is repeated for each usage condition (P-condition and C-condition) in the LT tag block. In step S42, the media write unit 15 judges whether the usage condition is P-condition or C-condition. When the usage condition is C-condition, the media write unit 15 converts the usage condition into a component of the UR-M. When the usage condition is P-condition, the media write unit 15 judges whether the P-condition is acceptable to the PDs 4a, 4b, and 4c, and the portable medium 3. When the P-condition is a usage condition for the usage action of audio reproduction and indicates reproduction quality, this condition is acceptable to the PDs 4a, 4b, and 4c, and therefore, the judgment result in step S43 is affirmative.

On the other hand, when the P-condition is a usage condition for the usage action of audio reproduction but indicates a usage condition acceptable to another portable medium 3 that is not the portable medium 3 owned by the user, this condition is not acceptable to the PDs 4a, 4b, and 4c. Therefore, the judgment result in step S43 is negative. Note that the judgment in step S43 should include for the user's personal view. Therefore, it is preferable that this judgment involves an operation interactive with the user.

The processing in step S44 is executed only for a usage condition whose judgment result in step S42 is negative and judgment result in step S43 is affirmative. In step S44, the usage condition is converted into a usage condition that constitutes the UR-M. The media write unit 15 repeats the processing in step S44 for each usage condition in the LT tag block, and then ends the processing.

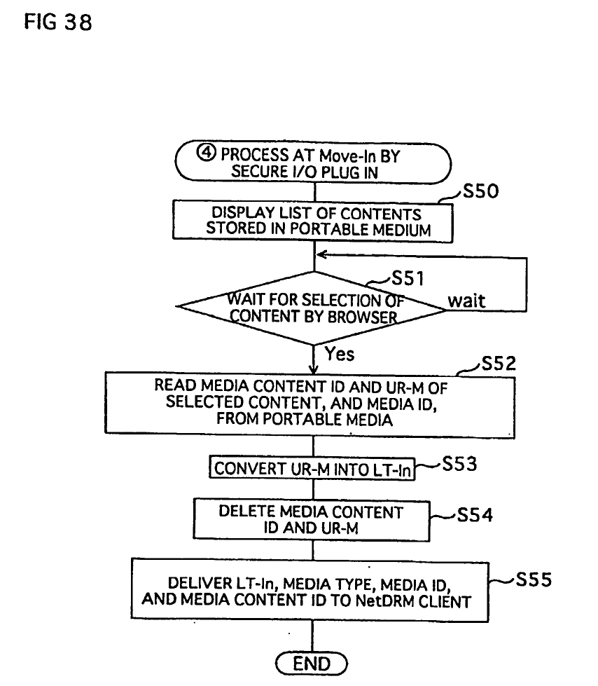

The following describes the operation procedure of the media read unit 17 and the secure I/O plug-in 10 when Move-In is performed, with reference to FIG. 38.

In step S50, the media read unit 17 makes the browser display a list of contents stored in the portable medium 3. In step S51, the media read unit 17 waits for a content to be selected via the browser. The media read unit 17 reads a media content ID and UR-M of the selected content, and a media ID, from the portable medium 3 in step S52. The media read unit 17 then converts the UR-M into an LT-In in step S53. The media read unit 17 then deletes the media content ID, the UR-M from the portable medium 3 in step S54, and delivers the LT-In, the media type, the media ID, and the media content ID, to the NetDRM client 8.

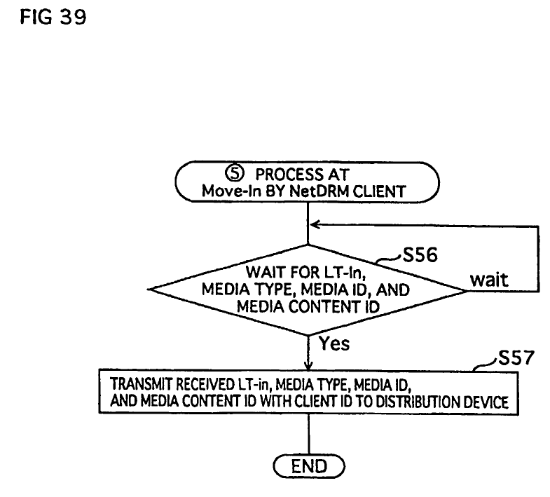

FIG. 39 is a flowchart showing the operation procedure of the Move-In control unit 16 in the NetDRM client 8 when Move-In is performed. In step S56, the Move-In control unit 16 waits for the LT-In, the media type, the media ID, and the media content ID. Upon receipt of these, the Move-In control unit 16 transmits the LT-In, the media type, the media ID, and the media content ID together with its client ID to the distribution device 1 in step S57.

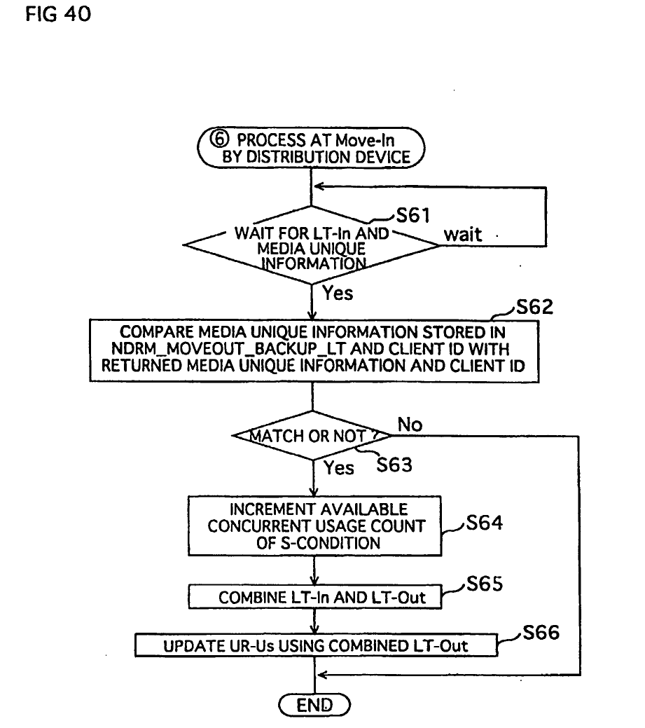

When the NetDRM client 8 and the secure I/O plug-in 10 perform Move-In, the media unique information for the portable medium 3 and the LT-In are returned from the NetDRM terminal device 2 to the distribution device 1. Upon receipt of the media unique information and the LT-In, the distribution device 1 updates the UR-Us according to a flowchart shown in FIG. 40.

The following describes the operation procedure of the distribution device 1 when Move-In is performed, with reference to the flowchart in FIG. 40. FIG. 40 is a flowchart showing the operation procedure of the update unit 26 and the verification unit 27 when Move-In is performed. In step S61, the verification unit 27 waits for the LT-In and the media unique information. Upon receipt of the LT-In and the media unique information, in step S62, the verification unit 27 compares media unique information and a client ID stored in the “NDRM_MOVEOUT_BACKUP_LT” respectively with the returned media unique information and client ID. When the above comparison result does not show a match, the judgment result in step S63 is negative, and the processing ends. When the above comparison result shows a match, the judgment result in step S63 is affirmative, and the Move-In update unit 26 executes steps S64 and S65, and then ends the processing. To be more specific, the Move-In update unit 26 increments the available concurrent usage count that is S-condition in step S64, and combines the LT-In and the LT-Out in step S65. In more detail, the Move-In update unit 26 reflects the usage condition included in the LT tag block in the LT-In, in the LT-Out stored in the NDRM_MOVEOUT_BACKUP_LT”. Wh n the usage condition is reflected in the LT-Out, the Move-In update unit 26 updates the UR-Us using this LT-Out in step S66. In more detail, the Move-In update unit 26 reflects the usage condition included in the LT tag block of the LT-Out, in the UR-Us. As described above, this results in the LT-In being reflected in the UR-Us.

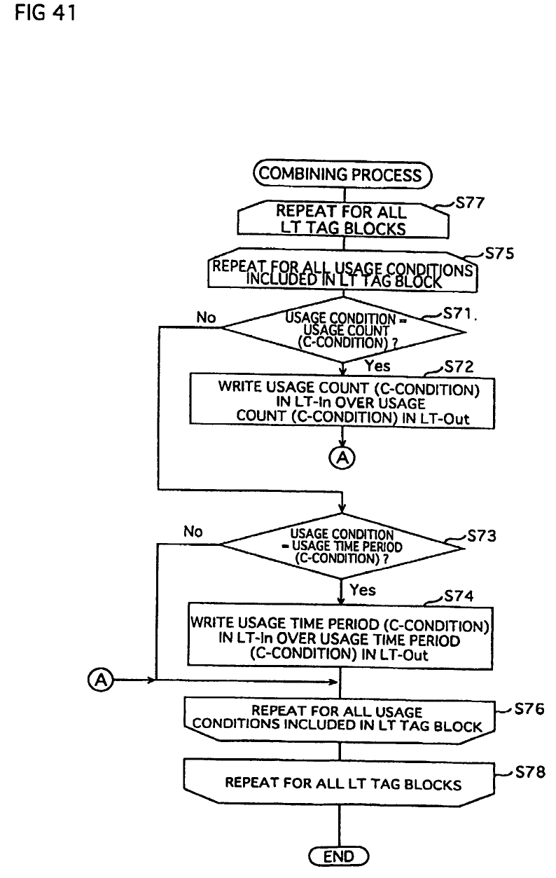

The combining process in step S65 is specifically shown as a flowchart in FIG. 41. The following describes the combining process in more detail, with reference to this flowchart. This flowchart involves a dual-loop structure in which the processing from steps S71 to S74 is repeated for each LT tag block that constitutes the LT-In (steps S75 and S76), and the processing from steps S71 to S76 is repeated for each usage condition included in each LT tag block (steps S77 and S78).

In step S71, the Move-In update unit 26 judges whether the C-condition is a usage count as employed in the first embodiment. When the judgment result in step S71 is affirmative, the Move-In update unit 26 writes the C-condition of the usage count in the LT-In over the C-condition of the usage count in the LT-Out in step S72.

In step S73, the Move-In update unit 26 judges whether the C-condition is a usage time period as employed in the second embodiment. When the judgment result in step S73 is affirmative, the Move-In update unit 26 writes the C-condition of the usage time period in the LT-In over the C-condition of the usage time period in the LT-Out in step S74. The Move-In update unit 26 repeats the processing described above for each usage condition included in the LT tag block, and then for each LT tag block, and ends the LT-In and LT-Out combining process.

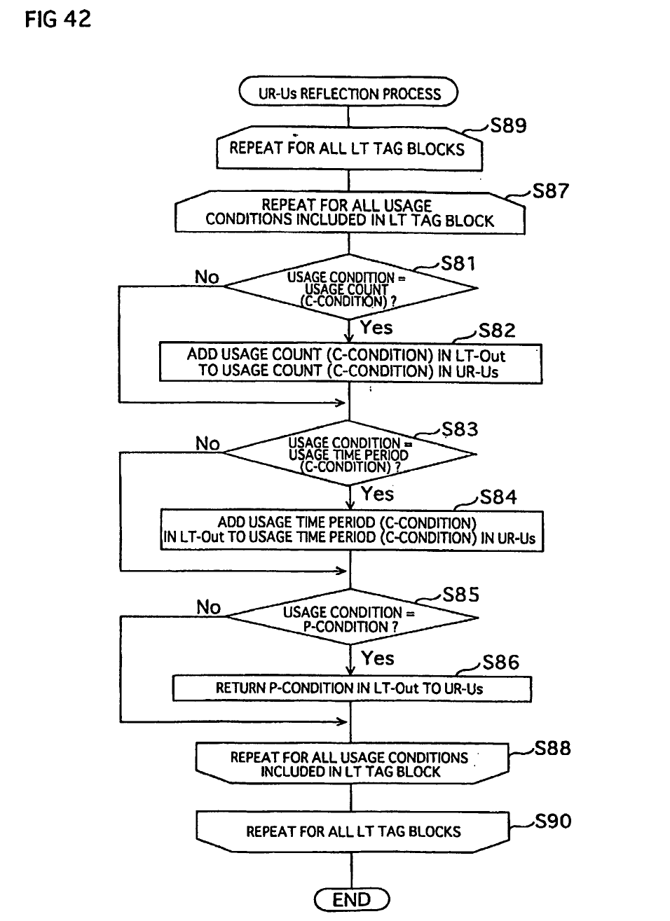

The following describes the UR-Us reflection process, with reference to a flowchart in FIG. 42. This flowchart involves a dual-loop structure in which the processing from steps S81 to S86 is repeated for each LT tag block that constitutes the LT-Out (steps S87 and S88), and the processing from steps S81 to S88 is repeated for each usage condition included in each LT tag block (steps S89 and S90).

In step S81, the Move-In update unit 26 judges whether the C-condition is a usage count as employed in the first embodiment. When the judgment result in step S81 is affirmative, the Move-In update unit 26 adds the C-condition of the usage count in the LT-Out to the C-condition in the UR-Us in step S82.

In step S83, the Move-In update unit 26 judges whether the C-condition is a usage time period as employed in the s cond embodiment. When the judgment result in step S83 is affirmative, the Move-In update unit 26 adds the C-condition of the usage time period in the LT-Out to the C-condition of the usage time period in the UR-Us in step S84. In step S85, the Move-In update unit 26 judges whether the usage condition is the P-condition or not. When the judgment result in step S85 is affirmative, the Move-In update unit 26 returns the P-condition in the LT-Out to the UR-Us in step S86. The Move-In update unit 26 repeats the processing described above for each usage condition included in the LT tag block, and then for each LT tag block, and ends the UR-Us reflection process.

As described above, the present embodiment enables the user to use one content on a plurality of devices concurrently, because the distribution device 1 manages the available concurrent usage count. Further, due to Move-Out and Move-In of each content being performed in the same way as in the first to fourth embodiments, such control that combines the S-condition, C-condition, and P-condition is enabled.

(Sixth Embodiment)

In the first to fifth embodiments, the user can use a digital work on the PDs 4a, 4b, and 4c, and the NetDRM terminal device 2 any time as long as the available usage count or the available usage time period is not 0. However, the service provider may wish to limit the term during which the user can use a digital work regardless of the available usage count or the available usage time period. This is because it might not be beneficial for the s rvic provider to keep user information managed by the distribution device 1 for an unlimited term as in the first to fifth embodiments.

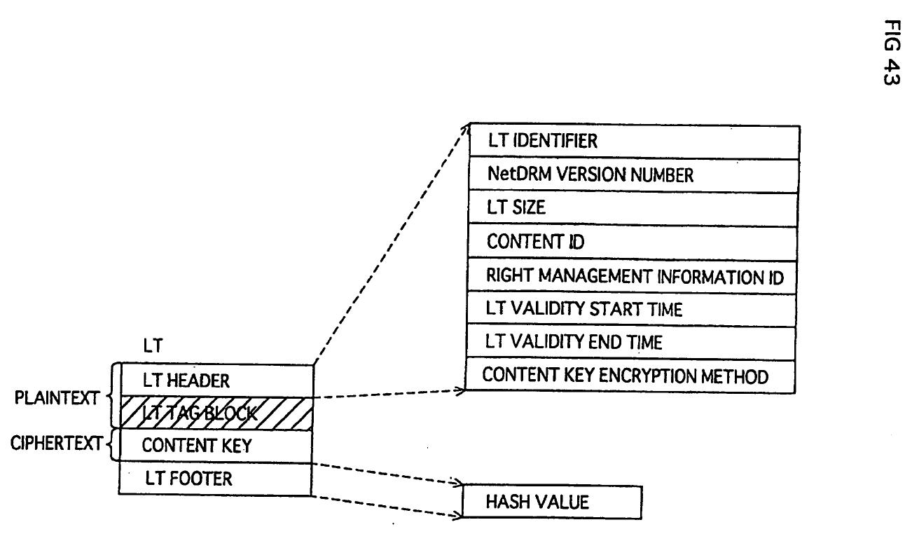

To limit the usage term to one month, one week, or the like, an LT in the sixth embodiment has the format shown in FIG. 43. The LT in this figure differs from the one in the first to fifth embodiments, in its LT header storing an LT validity start time and an LT validity end time as C-condition.

The LT validity start time indicates year/month/date, hour/minute/second, or the like, at which the validity term of the LT starts. The LT validity end time indicates year/month/data, hour/minute/second, or the like, at which the validity term of the LT ends.

The NetDRM terminal device 2 and the PDs 4a, 4b, and 4c compare the LT validity start time and the LT validity end time added in the LT, with the present year/month/date or hour/minute/second. When the present year/month/date or hour/minute/second is within the validity term indicated by the LT validity start time and the LT validity end time, the user is allowed to use a digital work in the same way as in the first to fifth embodiments.

When the present year/month/date and the like is beyond the validity term, the user is not allowed to use a digital work even if the usage count or the usage time period is not 0. When the validity term is expired while the digital work is being used, the digital work is immediately prohibited from being used at that particular point. The same applies to the NetDRM client 8 and the secure I/O plug-in 10. When the present year/month/date and the like is beyond the validity term, Move-Out and Move-In cannot be not started.

As described above, the present embodiment enables the usage term during which the user can use a digital work to be limited to one month, one week, or the like. After a predetermined time period elapses, therefore, various information for the user can be deleted. As a result, the service provided in the first to fifth embodiments can be realized while the management cost at the distribution device 1 is being reduced.

(Seventh Embodiment)

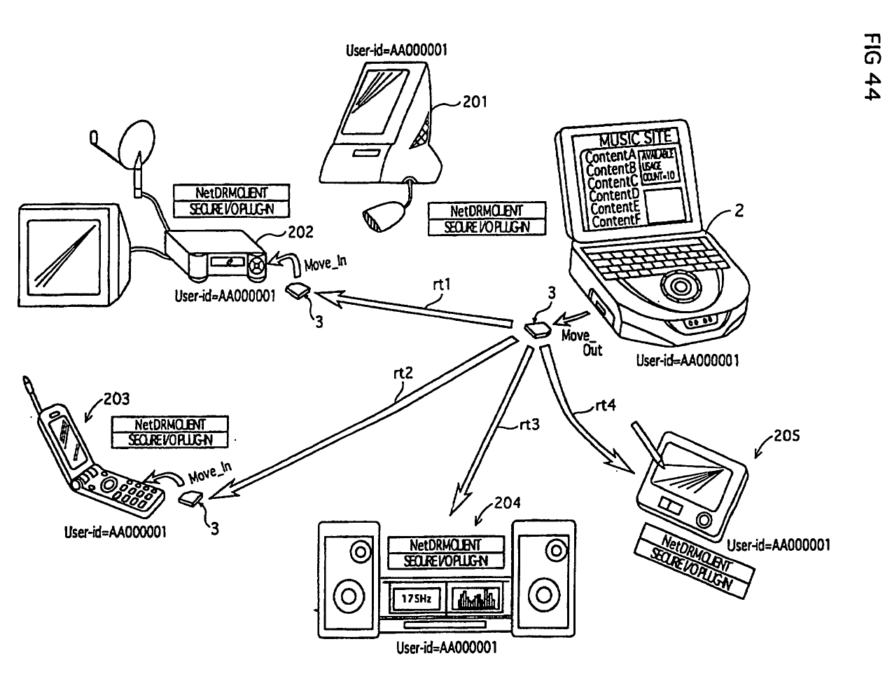

The seventh embodiment relates to an improvement in a case where one user owns a plurality of NetDRM terminal devices. FIG. 44 shows a plurality of NetDRM terminal devices owned by one user. A desktop personal computer 201, a set top box 202, a mobile phone 203, an audio server 204, and a PDA 205 each have the same structure as the NetDRM terminal device 2 in the figure. Also, they are functionally equivalent to the NetDRM terminal device 2 shown in FIGS. 6 and 7.

As being owned by the same user, these NetDRM terminal d vices are assigned one user ID “AA000001”. Accordingly, these NetDRM terminal devices 201 to 205 use various information in common, including the “NDRM_URUS”, “NDRM_CLIENT”, and “NDRM_MOVEOUT_BACKUP_LT” in the right management information database 19.

Each of these NetDRM terminal devices 201 to 205 in FIG. 44 is capable of performing Move-In of a digital work that a different NetDRM terminal device owned by the same user has recorded by Move-Out of the digital work. In FIG. 44, it is assumed that a digital work has been written to the portable medium 3 by the NetDRM terminal device 2 performing Move-Out of the digital work. When this portable medium 3 to which the digital work has been written is mounted upon the set top box 202 as indicated by arrow rt1, the set top box 202 is enabled to perform Move-In of this digital work from the portable medium 3. When the same portable medium 3 is mounted upon the mobile phone 203 as indicated by arrow rt2, the mobile phone 203 is enabled to perform Move-In of this digital work from the portable medium 3. The same is true of the audio server 204 and the PDA 205 as indicated by arrows rt3 and rt4.

Here, when a digital work is written to the portable medium 3 by the NetDRM terminal device of a notebook-sized personal computer performing Move-Out of the digital work, the user can perform Move-In of this digital work recorded on the portable medium 3 outdoors using the mobile phone 203. Due to this, freer download and upload of a digital work can be realized, such that the user can download and upload a digital work freely on his or her way to/from school or workplace. Furthermore, when the user wants to buy a new model of the NetDRM terminal device as one example, the user is not required to transfer data to the new one. Therefore, the user can readily replace it with a new one.

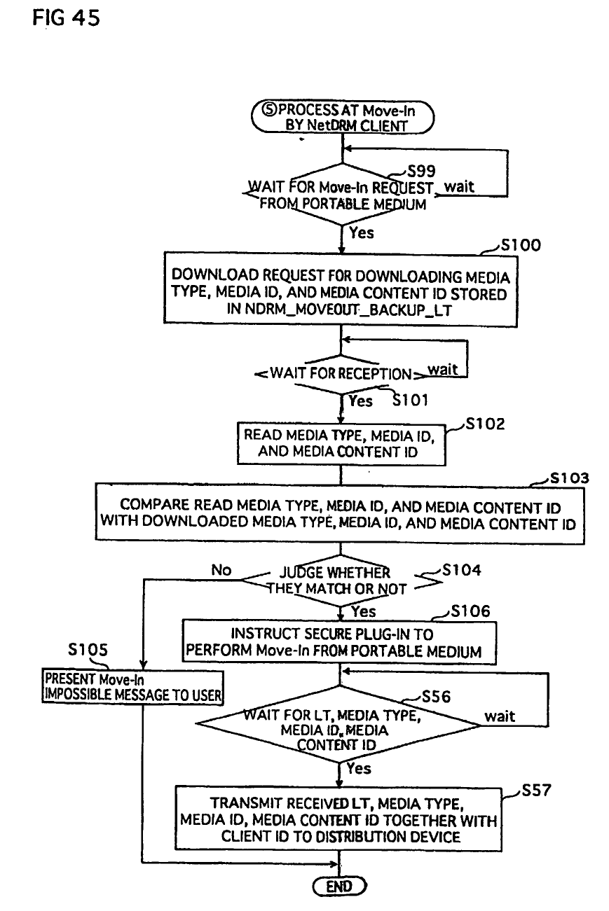

Here, the operation that needs to be guaranteed when a digital work is delivered between a plurality of NetDRM terminal devices owned by the same user is as follows. The operation is to prevent a third party from performing Move-In of the digital work using the third party's NetDRM terminal device. For this purpose, the NetDRM terminal devices 202 to 205 judge whether media unique information of the portable medium 3 to which Move-In is requested has been written by one of the NetDRM terminal devices owned by the user. This judgment is realized in the following way. The media unique information owned by the user stored in the “NDRM_MOVEOUT_BACKUP_LT” in the right management information database 19 of the distribution device 1, is downloaded, and the media unique information is read from the portable medium 3. The downloaded media unique information and the read media unique information are then compared. To be more specific, the NetDRM client 8 in the seventh embodiment executes the processing according to a flowchart shown in FIG. 45. FIG. 45 is the flowchart showing the operation procedure of the Move-In control unit 16 relating to the seventh embodiment.

In step S99, the Move-In control unit 16 waits for the user's Move-In request from the portable medium 3. Upon receipt of the Move-In request, the Move-In control unit 16 issues a download request for downloading a media type, a media ID, and a media content ID stored in the “NDRM_MOVEOUT_BACKUP_LT” to the distribution device 1 in step S100. The Move-In control unit 16 then waits for the media type, media ID, and media content ID stored in the “NDRM_MOVEOUT_BACKUP_LT” to be downloaded thereto in step S101. Upon receipt of these, the Move-In control unit 16 reads the media type, the media ID, and the media content ID from the portable medium 3 in step S102. Following this, the Move-In control unit 16 compares the read media type, media ID, and media content ID respectively with the downloaded media type, media ID, and media content in step S103. If the portable medium 3 from which Move-In is to be performed is the one to which Move-Out has been performed by a different NetDRM terminal device owned by the same user, the comparison result must show a complete match. If the portable medium 3 is the one to which Move-Out has been performed by a different terminal device owned by a third party, the comparison result must show a mismatch.

When the comparison result shows a mismatch, it is highly likely that the digital work recorded on the portable medium 3 from which Move-In is to be performed has been written by a third party. Therefore, the judgment result in step S104 is negative. An error is displayed and a Move-In impossible message is presented to the user in step S105, and then the processing ends. When the comparison result shows a match, the judgment result in step S104 is affirmative. The Move-In control unit 16 then instructs the secure I/O plug-in 10 to perform Move-In from the portable medium 3 in step S106, and executes steps S56 and S57 as in the flowchart shown in FIG. 39.

Note that the NetDRM terminal device 2 may transmit the media unique information to the distribution device 1, and the distribution device 1 may perform the above comparison. When the comparison result shows a match, the NetDRM terminal device 2 may perform Move-In.

As described above, the present embodiment enables a digital work recorded on the portable medium 3 by one NetDRM terminal device to be obtained by a different NetDRM terminal device owned by the same user, that is to say, the digital work to be delivered to the different device via the portable medium 3, thereby increasing user-friendliness.

(Eighth Embodiment)

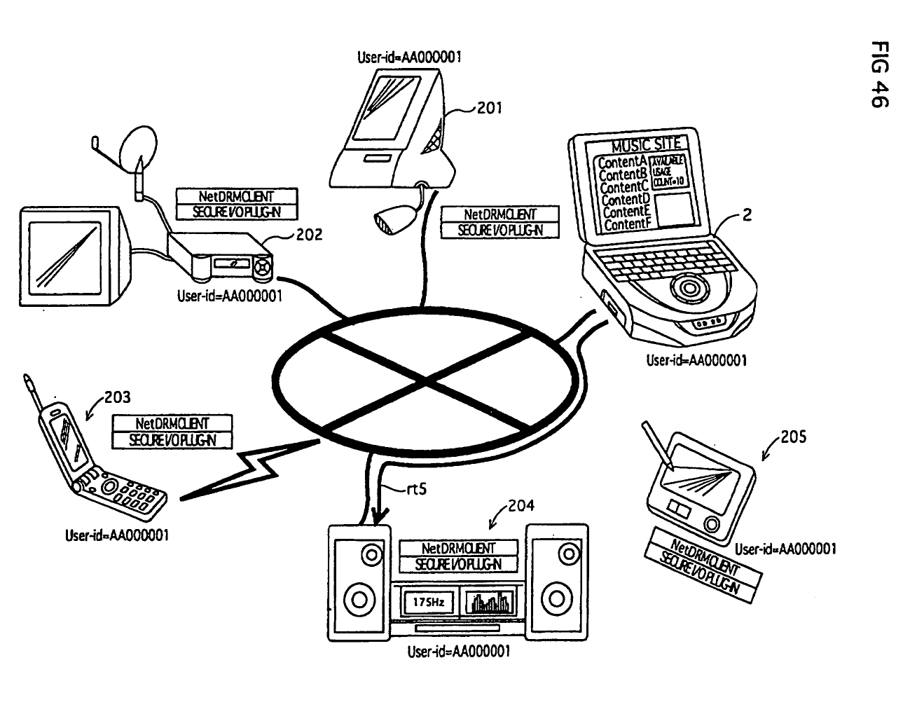

The eighth embodiment aims to create a home network by wiring or connecting wirelessly a plurality of NetDRM terminal devices owned by one user. FIG. 46 shows the plurality of NetDRM terminal devices connected via the home network relating to the eighth embodiment. This home network connects a desktop personal computer 201, a set top box 202, a mobile phone 203, an audio server 204, and a PDA 205, and realizes the processing in which a digital work downloaded by one of the NetDRM terminal devices is obtained by another one of the NetDRM terminal devices.

As one example, the audio server 204 that is a NetDRM terminal device issues a download request to a different NetDRM terminal device that is also owned by the same user. The NetDRM terminal to which the download request has been issued transmits encrypted content and an LT to the audio server 204 as indicated by arrow rt5. The audio server 204 receives the transmitted content and LT and stores them in its HD 7. In this way, the digital work can be obtained by a different device directly via the home network.

As described above, the present embodiment enables rapid and simple delivery of a digital work by network transmission.

(Ninth Embodiment)

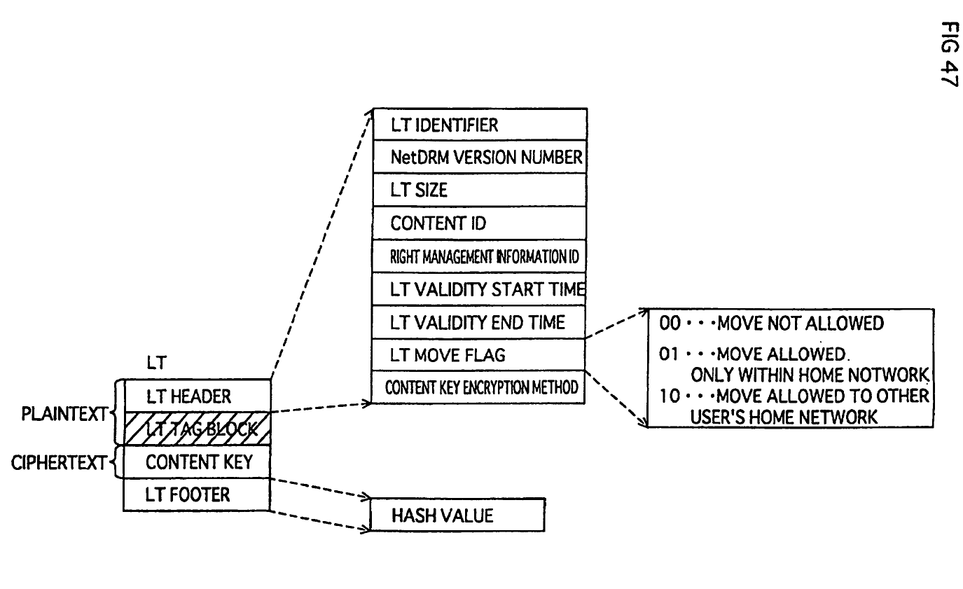

In the first to eighth embodiments, move is realized without any limitations on the acceptability. In the ninth embodiment, however, move-acceptability can be set in various levels. The data format of an LT r lating to the ninth embodiment is shown in FIG. 47. FIG. 47 shows the data format of the LT defined so that the move-acceptability can be set in various levels. The LT in the figure differs from the LT in the first to eighth embodiments, in that a move flag is set in its LT header.

The LT move flag is regarded as C-condition, and (1) a value “00” indicates that a digital work is not allowed to be moved, (2) a value “01” indicates that a digital work is allowed to be moved only within the home network, and (3) a value “10” indicates that a digital work is allowed to be moved not only within the user's home network but also to a home network of a different user.

The following describes the processing of the NetDRM terminal device 2 when an LT is provided with this LT move flag. When the LT move flag shows “01” or “10”, the NetDRM terminal device 2 performs Move-Out of this LT and its encrypted content in the same way as in the first to eighth embodiments. When the LT move flag shows “10”, the NetDRM terminal device 2 does not perform Move-Out. At the time of Move-Out, the NetDRM terminal device 2 converts the LT move flag into a component of UR-M, and writes it to the portable medium 3.

When the LT move flag shows “01” or “10”, the user is allowed to use the digital work on the PDs 4a, 4b, and 4c in the same way as in th first to eighth embodiments. When the LT move flag shows “10”, the user is allowed to use the content only on the NetDRM terminal device 2.

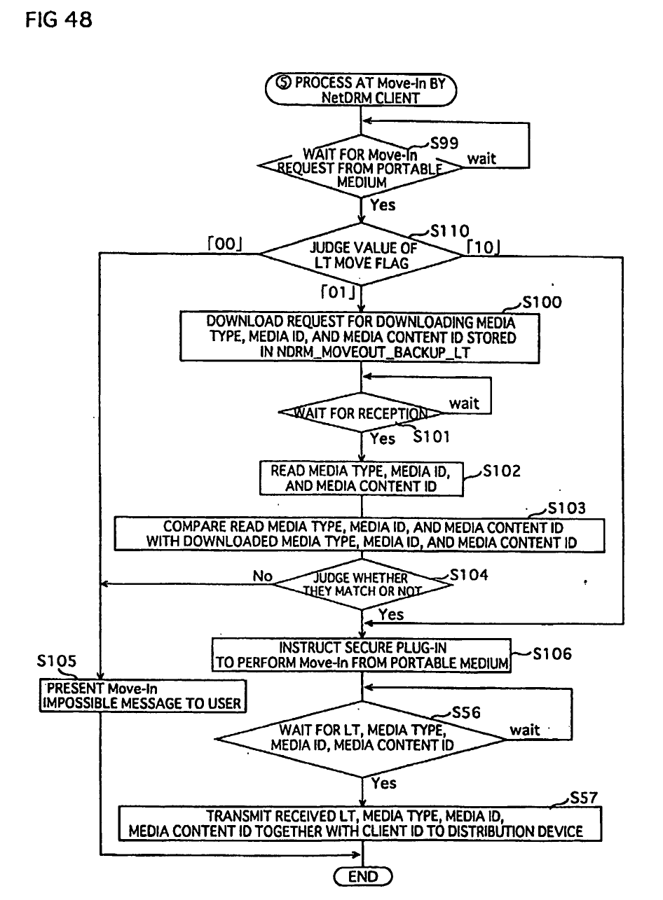

When Move-In of a digital work recorded on the portable medium 3 is requested, the NetDRM terminal device 2 executes the processing according to the setting of the LT move flag in the UR-M. To be more specific, when the LT move flag is set at “01”, the NetDRM terminal device 2 executes the judgment process described in the eighth embodiment. That is to say, when the LT move flag shows “01”, Move-In is performed only when the digital work has obviously been written to the portable medium 3 by a NetDRM terminal device owned by the same user. On the other hand, when the LT move flag shows “10”, the NetDRM terminal device 2 does not execute the judgment process shown in the eighth embodiment, and directly performs Move-In. In this way, when the LT move flag shows “10”, Move-In of the digital work that has been written by a NetDRM terminal device owned by a different user can also be performed. The operation to realize the above processing is described in a flowchart shown in FIG. 48. FIG. 48 is the flowchart showing the operation procedure of the Move-In control unit 16 in the ninth embodiment.

In step S99, the Move-In control unit 16 waits for a Move-In request from the user. Upon receipt of the Move-In request, the Move-In control unit 16 performs a judgment on a value of the LT move flag in step S110. When the LT move flag shows “00”, the processing advances to step S105, where an error display is performed. When the LT move flag shows “01”, the processing advances to S100, where the processing that it the same as in the eighth embodiment is performed. When the LT move flag shows “10”, the processing advances to step S106 with skipping steps S100 to S104, and Move-In is directly performed. Here, after Move-In is performed by the NetDRM terminal device 2 and the LT is uploaded, the distribution device 1 generates UR-Us corresponding to the LT and registers the generated UR-Us into the right management information database 19.

As described above, the present embodiment enables the move acceptability to be set in various levels, such that a highly important digital work is completely prohibited from being moved and is allowed to be used only within the NetDRM is terminal device 2, and a less important digital work is allowed to be delivered from one user to another. This can realize super-distribution content being in common use.

(Tenth Embodiment)

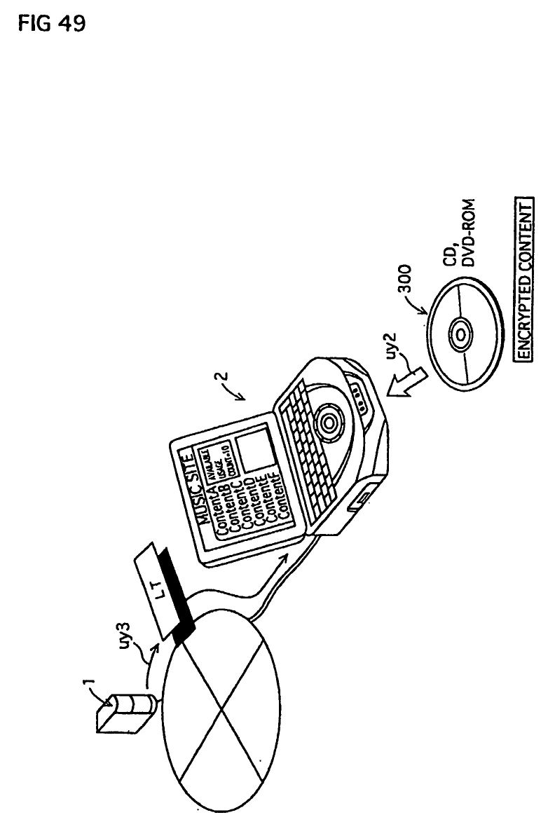

The first to ninth embodiments assume that encrypted content is transmitted together with an LT. In the tenth embodiment, however, encrypted content is supplied to the user on a different route from that for an LT. FIG. 49 shows the encrypted content and the LT each b ing suppli d on a different route. In the tenth embodiment, the encrypted content is recorded on a recording medium 300 such as a CD and a DVD-ROM, and distributed to stores and the like via the same distribution path as that for a commercial CD or DVD. The user who obtains the recording medium on which the encrypted content is recorded mounts the recording medium upon the NetDRM terminal device 2 as indicated by arrow uy2 in FIG. 49, and also obtains an LT including a content key and a usage condition for the encrypted content. The user then uses the encrypted content. In this way, the LT and the encrypted content are stored in the NetDRM terminal device 2, and then the digital work can be used in the same manner as described in the first to ninth embodiments.

As described above, the present embodiment enables encrypted content with a large data amount to be supplied to the user without via a network, and so the service described in the first to ninth embodiments can be realized using a network with smaller transmission capacity.

(Eleventh Embodiment)

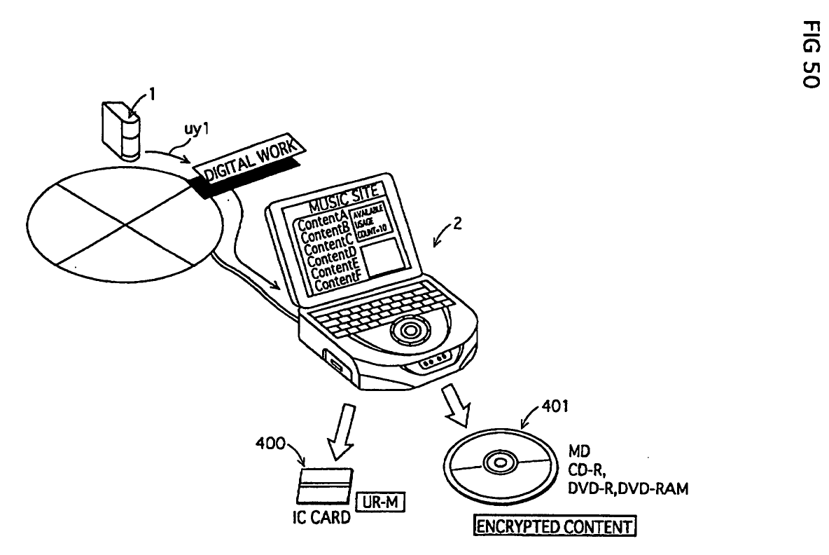

In the first to tenth embodiments, the NetDRM terminal device 2 writes UR-M and encrypted content to the portable medium 3. In the eleventh embodiment, however, the UR-M and the encrypted content each are written to a different medium. FIG. 50 shows how the NetDRM terminal device 2 performs Move-Out in the elev nth embodiment. In the figure, the NetDRM terminal device 2 writes the UR-M that is the usage condition to an IC card 400, and the encrypted content to a general recording medium 401 such as an MD, a CD, and a DVD. The UR-M and the encrypted content are respectively written to different media of the IC card 400 and the recording medium 401, and are carried separately in a physical way. The IC card 400 has the function of preventing tampering of data by unauthorized users as described for the portable medium 3 in the first embodiment. Due to this, the confidentiality of the UR-M can be ensured. On the other hand, the recording medium such as an MD, a CD, and a DVD can be obtained at lower cost than the portable medium 3 in the first embodiment. By combining these medium for use, the same effect as in the case where content is recorded on the portable medium 3 can be obtained.

As described above, the present embodiment enables the user to write encrypted content to a general recording medium and use the content. Therefore, the user is not required to purchase a semiconductor memory card or the like particularly for the service provided by this system. This alleviates an economical burden on the user, leading to further penetration of this service.

(Twelfth Embodiment)

The twelfth embodiment relates to a format in which a digital work is stored when the portable medium 3 is an SD memory card.

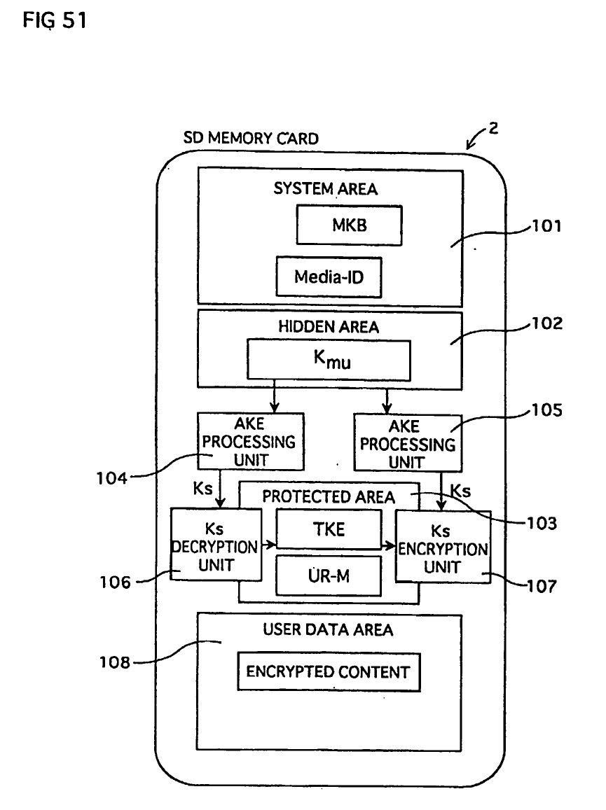

The portable medium 3 shown in the first to tenth embodiments is assumed to be an SD memory card 100 having the physical structure shown in FIG. 51 in the twelfth embodiment.

FIG. 51 shows the structure of the physical layer of the SD memory card 100. As the figure shows, the physical layer of the SD memory card 100 is composed of a system area 101, a hidden area 102, a protected area 103, an AKE processing unit 104, an AKE processing unit 105, a Ks decryption unit 106, a Ks encryption unit 107, and a user data area 108. The user data area 108 and the protected area 103 respectively correspond to the user area 6 and the protected area 5 in the portable medium 3 shown in FIG. 5.

The system area 101 is a read-only area for storing a media key block (MKB) and a media ID. The MKB and the media ID stored in this area cannot be overwritten. Assume that the SD memory card 100 is connected to other devices such as the NetDRM terminal device 2′, and the PDs 4a, 4b, and 4c, and that the MKB and the media ID are read by one of the connected devices. If that device correctly performs a predetermined calculation using the MKB, the media ID, and a device key Kd held internally, it can obtain a correct content key Kmu.

The hidden area 102 stores the content key Kmu having the correct value, i.e., the content key Kmu that must be obtained if the device performs correct calculation using the correct device key Kd.

The protected area 103 stores TKE and UR-M.

The AKE (Authentication and Key Exchange) processing units 104 and 105 perform challenge-respond type mutual authentication between a device and the SD memory card 100, verify the authenticity of the device, and if the device is invalid, stop processing. If the opposing device is valid, however, a content key (session key Ks) is shared by the device and the SD memory card 100. For this mutual authentication, the device connected to the SD memory card 100 performs the processing comprising three phases. The first is a challenge-1 phase where the device generates a random number, encrypts the random number using the content key Kmu, and transmits the encrypted value to the SD memory card 100 as a challenge value A. The second is a response-1 phase where the SD memory card 100 decrypts the challenge value A using the internally stored content key Kmu, and transmits the decrypted value to the device as a response value B. The third is a verify-1 phase where the device decrypts the internally stored challenge value A using its content key Kmu, and compares the decrypted value with the response value B transmitted from the SD memory card 100.

For the mutual authentication, on the other hand, the SD memory card 100 performs the processing also comprising three phases. The first phase is a challenge-2 phase where the SD memory card 100 generates a random number, encrypts the random number using the content key Kmu, and transmits the encrypted value to the connected device as a challenge value C. The second is a response-2 phase where the connected device decrypts the challenge value C using the internally stored content key Kmu, and transmits the decrypted value to the SD memory card 100 as a response value D. The third is a verify-2 phase where the SD memory card 100 decrypts the internally stored challenge value C using its content key Kmu, and compares the decrypted value with the response value D transmitted from the device.

If the device uses an improper content key Kmu for this mutual authentication, the challenge value A and the response value B in the verify-1 phase and the challenge value C and the response value D in the verify-2 phase do not match, and so the mutual authentication is suspended. If the authenticity of the device is verified, the AKE processing units 104 and 105 take an exclusive-OR of the challenge value A and the challenge value C and encrypts the resulting value using the content key Kmu, to obtain the session key Ks.

When encrypted TKE and UR-M to be written into the protected area 103 are outputted from the device connected to the SD memory card 100, the Ks decryption unit 106 assumes that the TKE and the UR-M have been encrypted using the session key Ks, and decrypts them using the session key Ks. Then, the Ks decrypting unit 106 writes the obtained TKE and the UR-M into the protected area 103, assuming the obtained TKE and the UR-M to be the original ones.

Upon receipt of a command instructing to read TKE and UR-M from a device connected to the SD memory card 100, the Ks encryption unit 107 encrypts the TKE and the UR-M stored in the protected area 103 using the session key Ks, and then outputs the encrypted TKE and UR-M to the device that issued the command.

The user data area 108 stores a plurality of encrypted contents and can be accessed by any connected device regardless of whether the authenticity of that device has been verified. If a content key read from the protected area 103 has a correct value, encrypted content stored in the user data area 108 can be correctly decrypted. Reading and writing of data to and from the protected area 103 is accompanied with decryption by the Ks decryption unit 106 and encryption by the Ks encryption unit 107. Therefore, the protected area 103 can usually be accessed only by a connected device that has successfully performed the AKE processing.

As described above, the present embodiment enables usage of digital works to be realized with full attention being paid to copyright protection.

Data structures and various processing disclosed in the embodiments of the present invention are based on the PCT published applications listed below, and so detailed technical information can be found therein. The PCT published applications are;

W0 00/65602 filed on Nov. 2, 2000;

W0 00/74054 filed on Dec. 7, 2000;

W0 00/74059 filed on Dec. 7, 2000;

W0 00/74060 filed on Dec. 7, 2000; and

W0 01/16821 filed on Mar. 8, 2001.

Note that the procedures described using the functional blocks and the flowcharts in the above first to eleventh embodiments (FIGS. 35 to 42, 45, and 48) may be realized by an execute-form program, and the execute-form program may be distributed or commercialized. The execute-form program is utilized with being installed on a general-purpose computer. The general-purpose computer successively executes the installed machine language program, and realizes the functions of the distribution device, the NetDRM terminal device, and the PDs described in the first to eleventh embodiments.

### INDUSTRIAL APPLICATION

The present invention enables users to view and listen to various digital works and to freely determine allocation of a usage condition to each digital work, thereby realizing distribution service with increased customer satisfaction. Therefore, the present invention is highly applicable in various industries with potential for the distribution service, such as the telecommunication industry, the book-publishing industry, and the film industry.

1. A distribution device, comprising:
a storage unit storing license information;
a transmission unit operable to read a part of the license information, transmit the read part together with a digital content to a user, and update the license information so as to be a remaining part, the remaining part being the license information excluding the read part; and
an increase unit operable to
(a) receive a decreased part that is the transmitted part decreased according to usage of the digital content, when the decreased part is returned from the user, and
(b) increase the remaining part based on the received decreased part by updating the license information.

2. The distribution device of claim 1,
wherein when the user requests another digital content, the transmission unit reads another part of the license information updated by the increase unit and transmits the read other part together with the other digital content, to the user.

3. The distribution device of claim 2,
wherein the license information stored by the storage unit is a total usage count “s”, “s” being an integer that satisfies “s≧2”,
the read part is a usage count “t” for the digital content, “t” being an integer that satisfies “t≦s”, and
the license information stored by the storage unit is updated to be a remaining usage count “s−t” after the digital content and the read part have been transmitted.

4. The distribution device of claim 3,
wherein the decreased part is a usage count “u”, “u” being an integer that satisfies “u<t”, and
the increase unit increases the remaining usage count “s−t” to a remaining usage count “s−t+u”.

5. The distribution device of claim 4,
wherein the transmission unit reads a usage count “v” that is the other part of the updated license information from the remaining usage count “s−t+u”, and transmits the read usage count “v” together with the other digital content, “v” being an integer that satisfies “v≦s−t+u”.

6. The distribution device of claim 5,
wherein the transmission unit further transmits threshold information to the user, the threshold information indicating a minimum usage time period of a digital content to be regarded as one count.

7. The distribution device of claim 5,
wherein the transmission unit further transmits action condition information to the user, the action condition information limiting a usage action of the digital content on a device owned by the user, and
the usage count indicates a number of times the usage action limited by the action condition can be performed.

8. The distribution device of claim 5,
wherein the usage count “t” transmitted together with the digital content is for a usage action of the digital content on a device owned by the user, and
the transmission unit further transmits, to the user, a usage count for a different usage action of the digital content on the device.

9. The distribution device of claim 2, further comprising:
a first reception unit operable to receive, from the user, media unique information that is unique to a recording medium to which the digital content is to be written;
a second reception unit operable to receive, from the user, media unique information that is uniqu to a recording medium to which the decreased part has been recorded; and
a judgment unit operable to judge whether the media unique information received by the first reception unit and the media unique information received by the second reception unit match or not,
wherein the increase unit increases the remaining part to update the license information only when a judgment result by the judgment unit is affirmative.

10. The distribution device of claim 2, further comprising:
a first reception unit operable to receive, from the user, client unique information that is unique to the user to which the digital content is to be transmitted;
a second reception unit operable to receive, from the user, client unique information that is unique to the user who has returned the decreased part; and
a judgment unit operable to judge whether the client unique information received by the first reception unit and the client unique information received by the second reception unit match or not,
wherein the increase unit increases the remaining part to update the license information only when a judgment result by the judgment unit is affirmative.

11. The distribution device of claim 2,
wherein the license information stored by the storage unit is a total usage time period “s”, “s” being an integer that satisfies “s≧2”,
the read part is a usage time period “t” for the digital content, “t” being an integer that satisfies “t≦s”, and
the license information is updated to be a remaining usage time period “s−t” after the digital content and the read part have been transmitted.

12. The distribution device of claim 11,
wherein the decreased part is a usage time period “u”, “u” being an integer that satisfies “u<t”, and the increase unit increases the remaining usage time period “s−t” to a usage time period “s−t+u”.

13. The distribution device of claim 12,
wherein the transmission unit reads a usage time period “v” that is the other part of the license information, “v” being an integer that satisfies “v≦s−t+u”, and transmits the usage time period “v” together with the other digital content.

14. The distribution device of claim 2,
wherein the license information is a usage count “s”, “s” being an integer that satisfies “s≦2”,
the transmission unit updates the license information to be a remaining usage count “s−t”, after transmitting the digital content together with the read part, “t” being an integer that satisfies “t≦s”, and
the increase unit increases the updated license information to be a usage count “s−t+u” when the decreased part is returned from the user, “u” being an integer that satisfies “u≦t”.

15. A terminal device that receives a digital content distributed by a distribution device that stores a digital content and license information, the terminal device comprising:
a reception unit operable to receive, from a user, a designation of a part of the license information to be allocated to the digital content;
a download unit operable to receive the digital content and the part from the distribution device, and write the received digital content and the part to a recording medium;
a usage unit operable to use the digital content within a range indicated by the part of the license information; and
an upload unit operable to
(a) obtain the part recorded on the recording medium and transmit the obtained part to the distribution device, and
(b) make the digital content recorded on th recording medium unusable.

16. The terminal device of claim 15,
wherein the part received by the download unit is a usage count “t”, “t” being an integer that satisfies “t≧1”,
the usage unit decrements the usage count “t” recorded on the recording medium every time when using the digital content once, and
the upload unit transmits a usage count “u” that is the decremented usage count “t”, “u” being an integer that satisfies “u≦t”.

17. The terminal device of claim 16,
wherein the download unit receives threshold information from the distribution device and writes the received threshold information to the recording medium, and
the usage unit decrements the usage count “t” recorded on the recording medium, when a usage time period of the digital content exceeds a predetermined time period indicated by the threshold information.

18. The terminal device of claim 16,
wherein the download unit receives action condition information from the distribution device and writes the received action condition information to the recording medium, the action condition information limiting a usage action on a device owned by the user, and
the usage count indicates a number of times the usage action limited by the action condition information can be performed.

19. The terminal device of claim 16,
wherein the usage count “t” is a usage count of a usage action on a device owned by the user, and
the download unit further receives a usage count of a different usage action from the distribution device and writes the received usage count to the recording medium.

20. The terminal device of claim 15,
wherein the part received by the download unit is a usage time period “t”,
the usage unit decreases the usage time period “t”, every time when using the digital content once, and
the upload unit transmits a usage time period “u” that is the decreased usage time period “t”, “u” being an integer that satisfies “u<t”.

21. The terminal device of claim 15,
wherein the recording medium is a portable recording medium that can be mounted upon the terminal device,
the terminal device further comprises:
a read unit operable to read, from the recording medium, media unique information that is unique to the recording medium;
a reception unit operable to receive, from the distribution device, media unique information that is registered with an identifier of the user in the distribution device; and
a judgment unit operable to judge whether the media unique information received by the reception unit and the media unique information read by the read unit match or not, and
the upload unit transmits the part recorded on the recording medium to the distribution device only when a judgment result by the judgment unit is affirmative.

22. A program that makes a computer execute a distribution process, the computer having a storage unit that stores a digital content and license information, the distribution process comprising:
a transmission step for reading a part of the license information, transmitting the read part together with a digital content to a user, and updating the license information so as to be a remaining part, the remaining part being the license information excluding the read part; and
an increase step for
(a) receiving a decreased part that is the transmitted part decreased according to usage of the digital content, when the decreased part is returned from the user, and
(b) increasing the remaining part based on the received decreased part by updating the license information.

23. The program of claim 22,
wherein when the user requests another digital content, another part of the license information updated in the increase step is read and the read other part is transmitted together with the other digital content to the user, in the transmission step.

24. The program of claim 23,
wherein the license information stored by the storage unit is a total usage count “s”, “s” being an integer that satisfies “s≧2”,
the read part is a usage count “t” for the digital content, “t” being an integer that satisfies “t≦s”, and
the license information stored by the storage unit is updated to be a remaining usage count “s−t” after the digital content and the read part have been transmitted.

25. The program of claim 24
wherein the decreased part is a usage count “u”, “u” being an integer that satisfies “u<t”, and
the remaining usage count “s−t” is increased to a remaining usage count “s−t+u” in the increase step.

26. The program of claim 25
wherein a usage count “v” that is the other part of the updated license information is read from the remaining usage count “s−t+u”, and the read usage count “v” is transmitted together with the other digital content in the transmission step, “v” being an integer that satisfies “v≦s−t+u”.

27. A computer-readable recording medium on which the program of claim 26 is recorded.

28. The program of claim 23,
wherein the license information stored by the storage unit is a total usage time period “s”, “s” being an integer that satisfies “s≧2”,
the read part is a usage time period “t” for the digital content, “t” being an integer that satisfies “t≦s”, and
the license information is updated to be a remaining usage time period “s−t” after the digital content and the read part have been transmitted.

29. The program of claim 28,
wherein the decreased part is a usage time period “u”, “u” being an integer that satisfies “u<t”, and the remaining usage time period “s−t” is increased to a usage time period “s−t+u” in the increase step.

30. The program of claim 29,
wherein a usage time period “v” that is the other part of the license information is read, “V” being an integer that satisfies “v≦s−t+u”, and the usage time period “v” is transmitted together with the other digital content, in the transmission step.

31. A computer-readable recording medium on which the program of claim 30 is recorded.

32. The program of claim 23,
wherein the license information is a usage count “s”, “s” being an integer that satisfies “s≦2”,
the license information is updated to be a remaining usage count “s−t”, after the digital content has been transmitted together with the read part in the transmission step, “t” being an integer that satisfies “t≦s”, and
the updated license information is increased to be a usage count “s−t+u” when the decreased part is returned from the user in the increase step, “u” being an integer that satisfies “u≦t”.

33. A computer-readable recording medium on which the program of claim 32 is recorded.

34. A program that makes a computer execute a transmission/reception process for receiving a digital content distributed by a distribution device that stores a digital content and license information, the transmission/reception process comprising:
a reception step for receiving, from a user, a designation of a part of the license information to be allocated to the digital content;
a download step for receiving the digital content and the part from the distribution device, and writing the received digital content and the part to a recording medium;
a usage step for using the digital content within a range indicated by the part of the license information; and
an upload step for
(a) obtaining the part recorded on the recording medium and transmitting the obtained part to the distribution device, and
(b) making the digital content recorded on the recording medium unusable.

35. The program of claim 34,
wherein the part received in the download step is a usage count “t”, “t” being an integer that satisfies “t≧1”,
the usage count “t” recorded on the recording medium is decremented every time when the digital content is used once in the usage step, and
a usage count “u” that is the decremented usage count “t” is transmitted in the upload step, “u” being an integer that satisfies “u≦t”.

36. A computer-readable recording medium on which the program of claim 35 is recorded.

37. The program of claim 34,
wherein the part received in the download step is a usage time period “t”,
the usage time period “t” is decreased, every time when the digital content is used once in the usage step, and
a usage time period “u” that is the decreased usage time period “t” is transmitted in the upload step, “u” being an integer that satisfies “u<t”.

38. A computer-readable recording medium on which the program of claim 37 is recorded.

39. The program of claim 34,
wherein the recording medium is a portable recording medium that can be mounted upon the terminal device,
the terminal device further comprises:
a read step for reading, from the recording medium, media unique information that is unique to the recording medium;
a reception step for receiving, from the distribution device, media unique information that is registered with an identifier of the user in the distribution device; and
a judgment step for judging whether the media unique information received in the reception step and the media unique information read in the read step match or not, and
the part recorded on the recording medium is transmitted to the distribution device in the upload step only when a judgment result in the judgment step is affirmative.

40. A computer-readable recording medium on which the program of claim 39 is recorded.

41. A distribution method for use in a computer having a storage unit that stores a digital content and license information, the distribution method comprising:
a transmission step for reading a part of the license information, transmitting the read part together with a digital content to a user, and updating the license information so as to be a remaining part, the remaining part being the license information excluding the read part; and
an increase step for
(a) receiving a decreased part that is the transmitted part decreased according to usage of the digital content, when the decreased part is returned from the user, and
(b) increasing the remaining part based on the received decreased part by updating the license information.

42. A transmission/reception method for use in a computer that receives a digital content distributed by a distribution device that stores a digital content and license information, the transmission/reception method comprising:
a reception step for receiving, from a user, a part of the license information to be allocated to the digital content;
a download step for receiving the digital content and the part from the distribution device, and writing the received digital content and the part to a recording medium;
a usage step for using the digital content within a range indicated by the part of the license information; and
an upload step for
(a) obtaining the part recorded on the recording medium and transmitting the obtained part to the distribution device, and
(b) making the digital content recorded on the recording medium unusable.
